(19) United States
(12) Patent Application Publication
(10) Pub. No.: US 2024/0388556 A1
(43) Pub. Date: Nov. 21, 2024

(54) INFORMATION NOTIFICATION METHOD, INFORMATION NOTIFICATION DEVICE, AND NON-TRANSITORY COMPUTER READABLE STORAGE MEDIUM

(71) Applicant: Panasonic Intellectual Property Corporation of America, Torrance, CA (US)

(72) Inventors: Mitsuhiro IMAO, Tokyo (JP); Hiroki TAKEUCHI, Osaka (JP)

(73) Assignee: Panasonic Intellectual Property Corporation of America, Torrance, CA (US)

(21) Appl. No.: 18/785,434

(22) Filed: Jul. 26, 2024

Related U.S. Application Data
(63) Continuation of application No. PCT/JP2022/040247, filed on Oct. 27, 2022.

(30) Foreign Application Priority Data
Feb. 1, 2022 (JP) 2022-014431

(51) Int. Cl. H04L 51/224; G06F 3/01; H04L 51/222

(52) U.S. Cl. CPC H04L 51/224; G06F 3/011; H04L 51/222

(57) ABSTRACT

An information notification method for notifying information by a modality which stimulates at least one of human five senses includes: by a computer, acquiring a current location of a notification target person; acquiring an activity intensity of the notification target person in the current location; determining, on the basis of the current location and the activity intensity, a first sort of modality that hinders an activity of the notification target person from a group of modalities that are available to notify the notification target person of the information; selecting a second sort of modality used to notify the notification target person of the information from among the modalities which are included in the group of modalities and are different from the first sort of modality; and notifying the notification target person of the information by the second sort of modality.

### FIELD OF INVENTION

The present disclosure relates to a technology of notifying a user of information.

### BACKGROUND ART

A technology of notifying a user of various kinds of information via a display and a speaker included in each of a mobile terminal of the user, and a home controller and an electric appliance each provided in a residence of the user has been conventionally known. For instance, Patent Literature 1 discloses determining a way of notifying information on the basis of a state of a user and a property of the information.

However, the technology of Patent Literature 1 is based on a general concept that an auditory notification way is more effective than a tactile notification way and a visual notification way is more effective than the auditory notification way to draw attention of the user as described in paragraph [0104], and thus fails to consider notifying the information without hindering an activity of the user.

Patent Literature 1: International Patent Application Publication No. 2015/198783

### SUMMARY OF THE INVENTION

The present disclosure has been achieved to solve the drawbacks described above, and has an object of providing an information notification method, an information notification device, and a non-transitory computer readable storage medium to attain a notification of information to a user without hindering an activity of the user.

An information notification method according to one aspect of the present disclosure is an information notification method for notifying information by a modality which stimulates at least one of human five senses. The information notification method includes: by a computer, acquiring a current location of a notification target person; acquiring an activity intensity of the notification target person in the current location; determining, on the basis of the current location and the activity intensity, a first sort of modality that hinders an activity of the notification target person from a group of modalities that are available to notify the notification target person of the information; selecting a second sort of modality used to notify the notification target person of the information from among the modalities which are included in the group of modalities and are different from the first sort of modality; and notifying the notification target person of the information by the second sort of modality.

### BRIEF DESCRIPTION OF THE DRAWINGS

FIG. 1 is a diagram showing an example of an overall configuration of an information notification system in an embodiment of the disclosure.

FIG. 2 is a table showing examples of outputting information respectively by output parts in an output system.

FIG. 3 is a block diagram showing an example of a configuration of an information notification device.

FIG. 4 is a flowchart showing an example of a notification process for information in the information notification device.

FIG. 5 is a table showing an example of notification request information.

FIG. 6 is a table showing an example of user situation information.

FIG. 7 is a view of an example activity estimation table.

FIG. 8 is a view of an example first rule table.

FIG. 9 is a view of an example second rule table.

FIG. 10 is a view of an example third rule table.

FIG. 11 is a view of an example including a fourth rule table and a sixth rule table.

FIG. 12 is an illustration of an example of a user situation input screen image.

### DETAILED DESCRIPTION

### Circumstances led up to This Disclosure

As aforementioned, a technology of notifying a user of various kinds of information via a display and a speaker included in each of a mobile terminal of the user, and a home controller and an electric appliance provided in a residence of the user has been conventionally known.

For instance, Patent Literature 1 discloses a notification method for drawing attention of the user on the basis of the concept that an auditory notification way is more effective than a tactile notification way and a visual notification way is more effective than the auditory notification way to draw the attention of the user. Hence, the technology of Patent Literature 1 has a risk of hindering the user from executing an activity due to the attention of the user to the notified information.

For instance, when the user needs to pay attention to notified information while cooking in a kitchen, the user may get burned or injured. Besides, when the user is notified of information by a home controller at a remote location from a living room while relaxing in the living room, the user may feel bothersome to move to the remote location to grasp a content of the information.

Under the circumstances, the present inventors have intensively studied the technology of notifying information without hindering an activity of a user and have conceived of the features described below.

(1) An information notification method according to one aspect of the present disclosure is an information notification method for notifying information by a modality which stimulates at least one of human five senses. The information notification method includes: by a computer, acquiring a current location of a notification target person; acquiring an activity intensity of the notification target person in the current location; determining, on the basis of the current location and the activity intensity, a first sort of modality that hinders an activity of the notification target person from a group of modalities that are available to notify the notification target person of the information; selecting a second sort of modality used to notify the notification target person of the information from among the modalities which are included in the group of modalities and are different from the first sort of modality; and notifying the notification target person of the information by the second sort of modality.

This configuration notifies the notification target person of information by the second sort of modality which is different from the first sort of modality that hinders the activity of the notification target person from the group of modalities that are available to notify the notification target person of the information. This configuration thus enables the notification target person to be notified of the information without hindering the activity of the notification target person.

(2) In the information notification method according to (1), in the determining of the first sort of modality, an activity content of the notification target person may be estimated from the current location and the activity intensity, and the first sort of modality may be determined on the basis of the activity content.

In this configuration, the first sort of modality is determined on the basis of the activity content of the notification target person estimated from the current location and the activity intensity of the notification target person. This configuration hence enables the notification target person to be notified of the information without hindering the activity indicated by the activity content.

(3) The information notification method according to (1) or (2) may further include: detecting another person who is different from the notification target person and located in a predetermined range from the current location; and adding, on the basis of an attribute of the another person or a situation of the another person, at least one of a modality that hinders an activity of the another person and a modality that has a possibility of leaking the information to be notified to the notification target person to the another person, to the first sort of modality.

In this configuration, at least one of a modality that hinders an activity of another person and a modality that has a possibility of leaking the information to be notified to the notification target person to another person is added to the first sort of modality. This configuration thus enables the notification target person to be notified of the information without hindering the activity of another person or leaking the information to be notified to the notification target person to another person.

(4) The information notification method according to any one of (1) to (3) may further include: acquiring a time period in which the current location is acquired; and adding, to the first sort of modality, a modality that is associated in advance with the time period and hinders an activity of a person.

In this configuration, a modality that is associated in advance with the time period in which the current location of the notification target person is acquired and hinders an activity of a person is added to the first sort of modality. This configuration thus enables the notification target person to be notified of the information without hindering an activity of a person in a time period in which the location of the notification target person is acquired.

(5) In the information notification method according to (1), in the determining of the first soft of modality, with reference to a table associating a location where the notification target person is likely to be with an intensity of an activity of the notification target person in the location and judgment information indicating whether each modality included in the group of modalities hinders the activity of the notification target person, a modality which is indicated to hinder the activity of the notification target person by the judgment information associated with the location agreeing with the current location and the intensity of the activity in the location agreeing with the activity intensity in the current location may be determined as the first sort of modality. The method may further include receiving a change in the content of the table.

This configuration succeeds in receiving a change in the content of the table for use in the determining of the first sort of modality. This configuration thus attains appropriate determination of the first sort of modality by appropriately changing the content of the table.

(6) In the information notification method according to any one of (1) to (5), in the selecting of the second sort of modality, a third sort of modality that is available to notify the information to the current location or a remote location farther than the current location may be selected as the second sort of modality from modalities which are included in the group of modalities and are different from the first sort of modality.

This configuration enables the notification target person who is in the current location to be reliably notified of the information by the third sort of modality that is available to notify the information to the current location of the notification target person or a remote location farther than the current location.

(7) In the information notification method according to (6), the modalities included in the group of modalities may be set in a first priority order, and, in the selecting of the second sort of modality, in a case where the third sort of modality includes a plurality of modalities, a modality having the highest rank in the first priority order in the third sort of modality may be selected as the second sort of modality.

This configuration succeeds in eliminating a bothersome feeling of the notification target person against a notification of the information by a modality having a lower rank in the first priority order than the third sort of modality.

(8) The information notification method according to any one of (1) to (7) may further include notifying the notification target person of an existence of the notification of the information by a fourth sort of modality that is available to notify the notification target person of the existence of the notification of the information to the current location or a remote rotation farther than the current location among the modalities which are included in the group of modalities and are different from the first sort of modality.

This configuration enables the notification target person who is in the current location to be reliably notified of the existence of the notification of the information by the fourth modality that is available to notify the information to the current location of the notification target person or a remote location farther than the current location.

(9) In the information notification method according to (8), the modalities included in the group of modalities may be set in a second priority order, and, in a case where the fourth sort of modality includes a plurality of modalities, the notification target person may be notified of the existence of the notification of the information by a modality having the highest rank in the second priority order in the fourth sort of modality.

This configuration succeeds in eliminating a bothersome feeling of the notification target person against a notification of the existence of the notification of the information by a modality having a lower rank in the second priority order than the fourth sort of modality.

(10) The information notification method according to any one of (1) to (9) may further include: removing a fifth sort of modality having a difficulty in drawing attention of the notification target person who is in the activity from the first sort of modality; and selecting the fifth sort of modality as the second sort of modality, and notifying the notification target person of the information more prominently than usual by the fifth sort of modality.

This configuration enables the notification target person to be notified of information more prominently than usual even by the fifth sort of modality having a difficulty in drawing attention of the notification target person, and hindering the activity of the notification target person. Hence, the notification target person can grasp the notified information without paying attention to the information through notification more easily than a usual notification of information by the fifth sort of modality. This consequently attains a reduction in the possibility of hindering the activity of the notification target person.

(11) The information notification method according to any one of (1) to (10) may further include: determining, on the basis of the current location and the activity intensity, a sixth sort of modality that hinders the activity of the notification target person from a group of input modalities that are available for an input of the information by the notification target person; and selecting a seventh sort of modality for the input of the information by the notification targe person from among modalities which are included in the group of input modalities and are different from the sixth sort of modality. In the notifying of the information by the second sort of modality, a notification that an input of the information by the seventh sort of modality is available may be further given.

This configuration notifies the notification target person of availability of an input of information by the seventh sort of modality which is different from the sixth sort of modality that hinders an activity of the notification target person. This allows the notification target person to input information by the seventh sort of modality without hindering the activity.

(12) In the information notification method according to any one of (1) to (11), in the acquiring of the current location, a sensor may be used to detect whether the notification target person is in a space where the sensor is arranged, and the space where the sensor having detected the notification target person is arranged may be acquired as the current location.

This configuration enables automatic acquisition of the current location of the notification target person by using the sensor.

(13) The information notification method according to any one of (1) to (11) may further include receiving an input of the current location. In the acquiring of the current location, the received current location may be acquired.

This configuration enables an input of the current location of the notification target person.

(14) In the information notification method according to any one of (1) to (13), in the acquiring of the activity intensity, a sensor may be used to detect an action speed of the notification target person in a space where the sensor is arranged, and the activity intensity may be acquired on the basis of the action speed of the notification target person.

This configuration enables automatic acquisition of the activity intensity of the notification target person on the basis of the action speed of the notification target person detected by the sensor.

(15) In the information notification method according to any one of (1) to (13), in the acquiring of the activity intensity, a sensor may be used to detect a posture of the notification target person in a space where the sensor is arranged, and the activity intensity may be acquired on the basis of the posture of the notification target person.

This configuration enables automatic acquisition of the activity intensity of the notification target person on the basis of the posture of the notification target person detected by the sensor.

(16) In the information notification method according to any one of (1) to (13), in the acquiring of the activity intensity, among two acquisition ways consisting of a way of using a sensor to detect an action speed of the notification target person and acquiring an activity intensity on the basis of the detected action speed of the notification target person and a way of using a sensor to detect a posture of the notification target person and acquiring the detected activity intensity, one way that is associated in advance with the current location may be performed to acquire the activity intensity.

This configuration enables automatic acquisition of the activity intensity of the notification target person in accordance with the current location of the notification target person on the basis of the action speed or the posture of the notification target person detected by the sensor.

(17) In the information notification method according to any one of (1) to (13), in the acquiring of the activity intensity, among two acquisition ways consisting of a way of using a sensor to detect an action speed of the notification target person and acquiring an activity intensity on the basis of the detected action speed of the notification target person and a way of using a sensor to detect a posture of the notification target person and acquiring the detected activity intensity, one way that is associated in advance with the number of postures which the notification target person is likely to take in the current location may be performed to acquire the activity intensity.

This configuration enables automatic acquisition of the activity intensity of the notification target person in accordance with the number of postures which the notification target person is likely to take in the current location of the notification target person on the basis of the action speed or the posture of the notification target person detected by the sensor.

(18) The information notification method according to any one of (1) to (13) may further include receiving an input of the activity intensity. In the acquiring of the activity intensity, the received activity intensity may be acquired.

This configuration enables an input of the activity intensity of the notification target person in the current location.

(19) An information notification device according to another aspect of the present disclosure is an information notification device that notifies information by a modality which stimulates at least one of human five senses. The information notification device includes: a first acquisition part that acquires a current location of a notification target person; a second acquisition part that acquires an activity intensity of the notification target person in the current location; a determination part that determines, on the basis of the current location and the activity intensity, a first sort of modality that hinders an activity of the notification target person from a group of modalities that are available to notify the notification target person of the information; a selection part that selects a second sort of modality used to notify the notification target person of the information from among the modalities which are included in the group of modalities and are different from the first sort of modality; and a notification part that notifies the notification target person of the information by the second sort of modality.

This configuration achieves the same operational effect as that of the information notification method.

(20) A non-transitory computer readable storage medium according to another aspect of the present disclosure is a non-transitory computer readable storage medium storing a program that causes a computer included in an information notification device that notifies information by a modality which stimulates at least one of human five senses. The program includes causing the computer to serve as: a first acquisition part that acquires a current location of a notification target person; a second acquisition part that acquires an activity intensity of the notification target person in the current location; a determination part that determines, on the basis of the current location and the activity intensity, a first sort of modality that hinders an activity of the notification target person from a group of modalities that are available to notify the notification target person of the information; a selection part that selects a second sort of modality used to notify the notification target person of the information from among the modalities which are included in the group of modalities and are different from the first sort of modality; and a notification part that notifies the notification target person of the information by the second sort of modality.

This configuration achieves the same operational effect as that of the information notification method.

This disclosure can be realized as a system caused to operate by the program as well. Additionally, it goes without saying that the computer program is distributable as a non-transitory computer readable storage medium like a CD-ROM, or distributable via a communication network like the Internet.

Each of the embodiments which will be described below represents a specific example of the disclosure. Numeric values, shapes, constituent elements, steps, and the order of the steps described below in each embodiment are mere examples, and thus should not be construed to delimit the disclosure. Moreover, constituent elements which are not recited in the independent claims each showing the broadest concept among the constituent elements in the embodiments are described as selectable constituent elements. The respective contents are combinable with each other in all the embodiments.

### First Embodiment

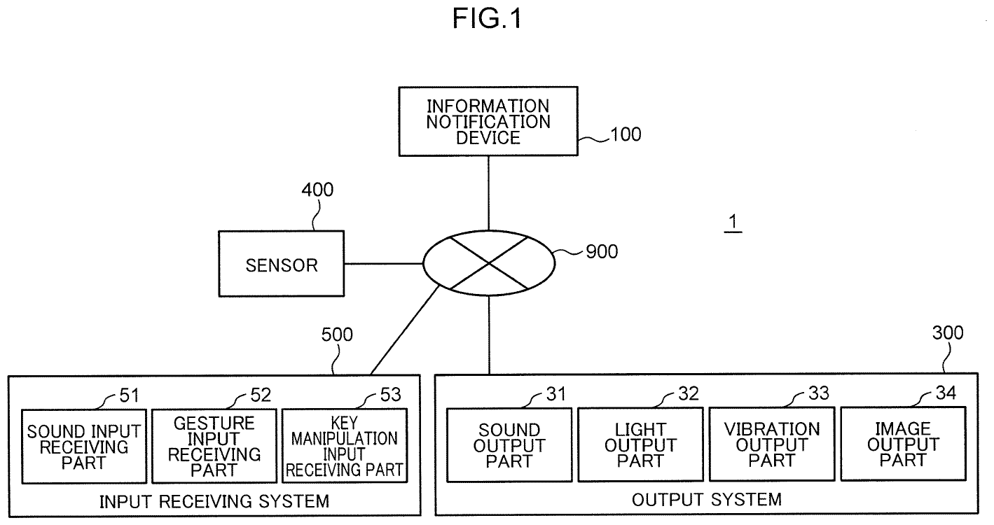

Hereinafter, an embodiment of the disclosure will be described with reference to the accompanying drawings. FIG. 1 is a diagram showing an example of an overall configuration of an information notification system 1 in the embodiment of the disclosure. The information notification system 1 includes a sensor 400, an output system 300, an input receiving system 500, and an information notification device 100.

The sensor 400, the output system 300, the input receiving system 500, and the information notification device 100 are communicably connected to one another via a network 900. The network 900 includes, for example, a public communication network like the internet. The network 900 may be a local area network.

The sensor 400 is arranged in a space in a facility which the user uses in the information notification system 1. The sensor 400, the input receiving system 500, and the output system 300 may be communicably connected to one another via the local area network in the facility.

Examples of the facility include a residence. The residence may be a condominium or apartment, or a house. Alternatively, the facility may be an office. When the facility indicates the residence, the user is a resident there. Examples of the space include a living room, a dining room, a kitchen, a living-dining-kitchen room (LDK), a western-style room, a Japanese-style room, a hallway, a toilet room, an entrance, and a bathroom. The term “LDK” means a space including a living room, a dining room, and a kitchen in combination. When the facility indicates an office, the user represents a user of the office. Examples of the space include a working room, a conference room, a kitchenette, a reception room, a lobby, a hallway, and a toilet room.

The sensor 400 periodically detects information about a space provided with the sensor 400. The sensor 400 transmits, to the information notification device 100, information (hereinafter, referred to as “sensor information”) including identification information of the sensor 400, detected information (hereinafter, referred to as “detection information”), and information (hereinafter, referred to as “detection date and time information”) indicating a date and time at detection of the information. The sensor 400 includes a monitoring camera, a distance measurement sensor, a radio wave sensor, and a beacon sensor.

The monitoring camera captures an image of a space where the monitoring camera is arranged and transmits sensor information including image data showing the captured image as the detection information. The distance measurement sensor detects a distance to a person who is in a predetermined direction from the distance measurement sensor with, for example, a light ray such as an infrared ray, a radio wave, or an ultrasonic wave, and transmits sensor information including the detected distance as the detection information.

The radio wave sensor detects a contour or shape of a person who is in the space with a field strength of the radio wave and detects a relative location of the person to an arrangement position of the radio wave sensor serving as a reference. The radio wave sensor transmits sensor information including the data (hereinafter, referred to as “contour data”) showing the detected contour of the person and the relative location of the person as the detection information.

The beacon sensor detects identification information of a person who is within a predetermined distance from the beacon sensor and a relative location of the person to an arrangement position of the beacon sensor serving as a reference. Specifically, the beacon sensor is configured to receive a beacon signal from a mobile terminal carried by the person who is in the predetermined distance from the beacon sensor. On receipt of the beacon signal, the beacon sensor acquires the identification information of the person and a relative location of the mobile terminal to the arrangement position of the beacon sensor serving as a reference, the identification information and the relative location being contained in the beacon signal. The beacon sensor transmits sensor information including the identification information of the person and the relative location of the mobile terminal as detection information.

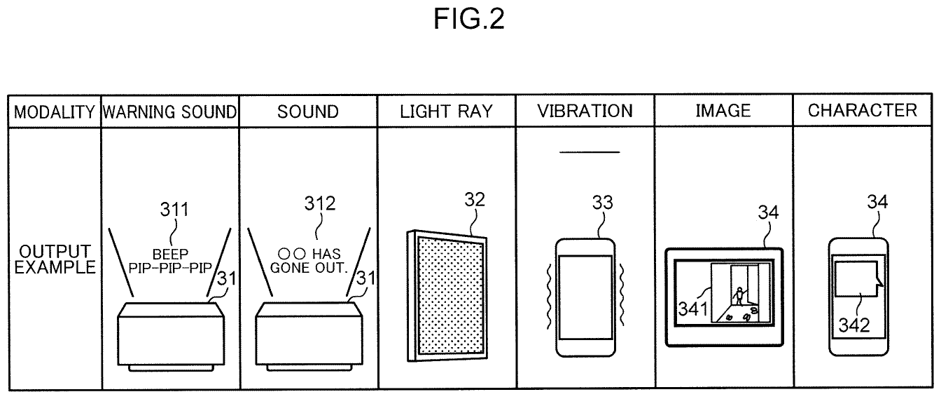

The output system 300 outputs various kinds of information by a modality which stimulates at least one of human five senses in accordance with an instruction from the information notification device 100. The modality includes a warning sound and a sound or voice each stimulating a sense of hearing, a light ray stimulating a sense of sight, a vibration stimulating a sense of touch, and an image and a character each stimulating the sense of sight. The output system 300 includes four output parts of a sound output part 31, a light output part 32, a vibration output part 33, and an image output part 34. FIG. 2 is a table showing examples of outputting information respectively by output parts in the output system 300.

The sound output part 31 includes, for example, a smart speaker, a speaker located on a ceiling or side wall in a room, or a speaker included in an electric appliance. Examples of the electric appliance include a smartphone, a tablet terminal, a personal computer, and a home controller. As shown in FIG. 2, the sound output part 31 outputs a warning sound 311 designated by the information notification device 100. The warning sound 311 includes a beep sound or an electric sound, having a frequency which is higher than that of a human voice by a predetermined degree or larger. The sound output part 31 outputs a sound or voice 312 designated by the information notification device 100.

The light output part 32 includes, for example, lighting equipment located on a ceiling or a side wall in a room or a lighting device included in an electric appliance. Examples of the electric appliance include a smartphone, a tablet terminal, a personal computer, and a home controller. As shown in FIG. 2, the light output part 32 outputs a light ray in a color designated by the information notification device 100. The light output part 32 further outputs a flashing light ray at time intervals designated by the information notification device 100.

The vibration output part 33 includes, for example, a vibrator in an electric appliance, such as a smartphone or a tablet terminal. As shown in FIG. 2, the vibration output part 33 vibrates the electric appliance including the vibration output part 33 in a vibration pattern designated by the information notification device 100.

The image output part 34 includes, for example, a display included in an electric appliance, or a television. Examples of the electric appliance include a smartphone, a tablet terminal, a personal computer, and a home controller. As shown in FIG. 2, the image output part 34 displays a still image or a video image 341 designated by the information notification device 100. The image output part 34 displays a character image (text) 342 designated by the information notification device 100.

Two or more output parts among the sound output part 31, the light output part 32, the vibration output part 33, and the image output part 34 may be included in a single electric appliance. Alternatively, the sound output part 31, the light output part 32, the vibration output part 33, and the image output part 34 may be included in electric appliances respectively and independently of one another.

The input receiving system 500 receives information input by a modality which stimulates at least one of the human five senses and transmits the received information to the information notification device 100. The modality includes a sound or voice stimulating the sense of hearing, a gesture stimulating the sense of sight, and a key manipulation stimulating the sense of touch. The input receiving system 500 includes three input receiving parts of a sound input receiving part 51, a gesture input receiving part 52, and a key manipulation input receiving part 53.

The sound input receiving part 51 includes, for example, a microphone included in an electric appliance. Examples of the electric appliance include a smartphone, a tablet terminal, a personal computer, and a home controller. The sound input receiving part 51 acquires a sound or voice representing an utterance of the user and receives information recognized from the acquired sound.

The gesture input receiving part 52 includes, for example, a monitoring camera located on a ceiling or a side wall of a room, or a camera included in an electric appliance. Examples of the electric appliance include a smartphone, a tablet terminal, a personal computer, and a home controller. The gesture input receiving part 52 captures an image of a predetermined area around the gesture input receiving part 52 and detects whether the captured image includes an image showing a predetermined gesture. On detection that the captured image includes the image showing the predetermined gesture, the gesture input receiving part 52 receives information associated with the gesture.

The key manipulation input receiving part 53 includes, for example, a hard key included in an electric appliance, a touch screen device, or a keyboard and a mouse included in a personal computer. Examples of the electric appliance include a smartphone, a tablet terminal, a personal computer, and a home controller. When a soft key is manipulated by using at least one of the touch screen device, the keyboard, and the mouse, the key manipulation input receiving part 53 receives information associated with the soft key. When the hard key is manipulated, the key manipulation input receiving part 53 receives information associated with the hard key. When the keyboard is manipulated, the key manipulation input receiving part 53 receives information associated with the manipulated key.

Two or more input receiving parts among the sound input receiving part 51, the gesture input receiving part 52, and the key manipulation input receiving part 53 may be included in a single electric appliance together. Alternatively, the sound input receiving part 51, the gesture input receiving part 52, and the key manipulation input receiving part 53 may be included in electric appliances respectively and independently of one another.

An appliance constituting each input receiving part included in the input receiving system 500 may serves as the sensor 400.

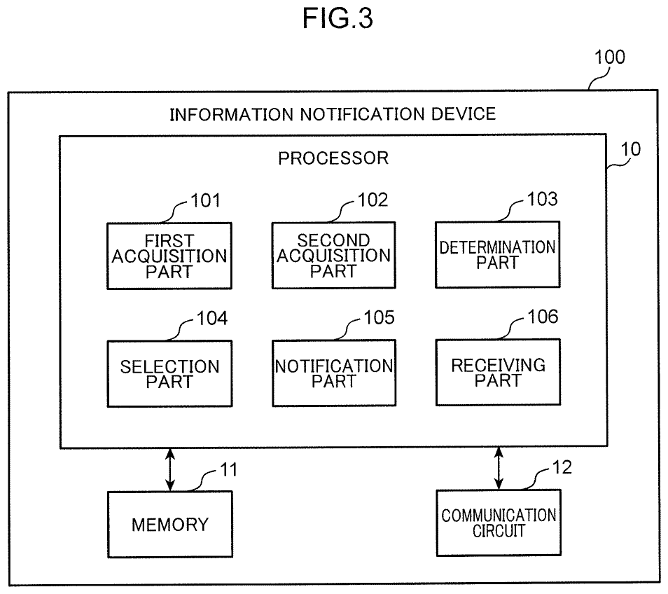

The information notification device 100 includes a cloud server, an edge server in a facility, a personal computer, and the like. FIG. 3 is a block diagram showing an example of a configuration of the information notification device 100. As shown in FIG. 3, the information notification device 100 includes a communication circuit 12, a processor 10 (computer), and a memory 11.

The communication circuit 12 complies with a communication protocol using the network 900, such as the Ethernet (registered trademark), and connects the information notification device 100 to the network 900.

The communication circuit 12 outputs various kinds of information received via the network 900 to the processor 10. For instance, the communication circuit 12 receives sensor information from the sensor 400 via the network 900 and outputs the received sensor information to the processor 10. The communication circuit 12 receives the information input by the user from the input receiving system 500 via the network 900 and outputs the received information to the processor 10. The communication circuit 12 transmits the various kinds of information to an external device connected to the network 900 via the network 900 under the control by the processor 10.

The processor 10 includes, for example, a central processing unit (CPU). The processor 10 has a first acquisition part 101, a second acquisition part 102, a determination part 103, a selection part 104, a notification part 105, and a receiving part 106. Each of the first acquisition part 101 to the receiving part 106 may be realized when the processor 10 executes a predetermined program, or may be established in the form of a dedicated hardware circuit. The receiving part 106 receives the information received from the input receiving system 500 by the communication circuit 12. The first acquisition part 101 to the notification part 105 will be described in detail later.

The memory 11 includes a rewritable non-volatile semiconductor memory, such as a flush memory, a hard disk drive (HDD), and a solid state drive (SSD).

The processor 10 causes the memory 11 to store the sensor information received by the communication circuit 12 from the sensor 400. The memory 11 further stores various kinds of information necessary for the processor 10 to execute a process.

For instance, the memory 11 stores information about a floor layout (hereinafter, referred to as “floor layout information”) of a facility. The floor layout information includes information indicating a contour or shape and a position of each space in the facility.

The memory 11 stores information about an appliance (hereinafter, referred to as “appliance information”) constituting each of the sensor 400, the input receiving system 500, and the output system 300.

The appliance information about the sensor 400 includes information indicating the arrangement position of the sensor 400 and the identification information of the sensor 400.

The appliance information about the input receiving system 500 includes identification information of an appliance constituting each of the sound input receiving part 51, the gesture input receiving part 52, and the key manipulation input receiving part 53, and information indicating the arrangement position of the appliance.

The appliance information about the output system 300 includes identification information of an appliance constituting each of the sound output part 31, the light output part 32, the vibration output part 33, and the image output part 34, information indicating the arrangement position of the appliance, and an address indicating a destination for transmission of a control command to the appliance.

The memory 11 stores information about each of users (hereinafter, referred to as “user information”) related to a facility. The user information includes identification information of the user (hereinafter, referred to as a “user ID”) and information indicating an attribute of the user (hereinafter, referred to as “attribute information”). The attribute information about the user includes an age and a gender of the user. The attribute information about the user further includes a group (e.g., a department) to which the user belongs.

The memory 11 stores, in association with the user ID of the user, collation data for collation with the sensor information detected by the sensor 400 to recognize the user. Specifically, the collation data includes various kinds of data indicating the characteristics of the user, such as image data indicating an image obtained by photographing a face or a full body of the user.

The memory 11 stores various rule tables each defining a rule for determining a modality which is used to notify the user of information. The various rule tables will be described in detail later.

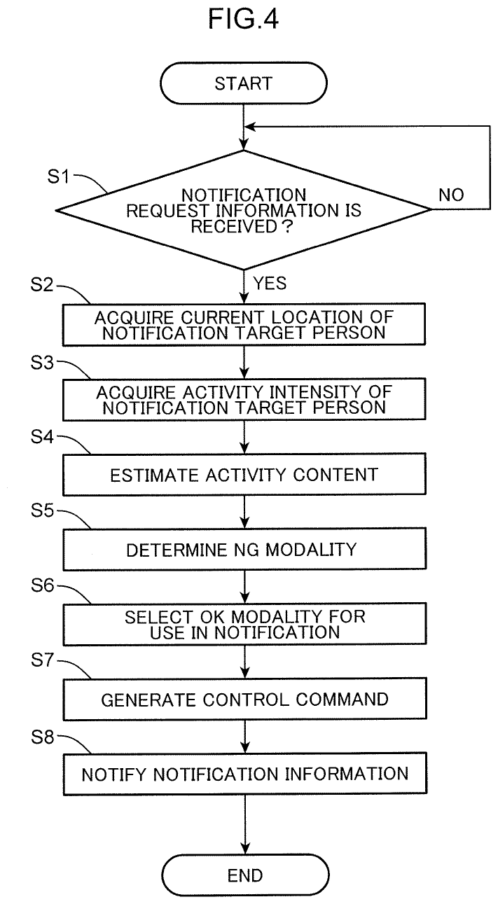

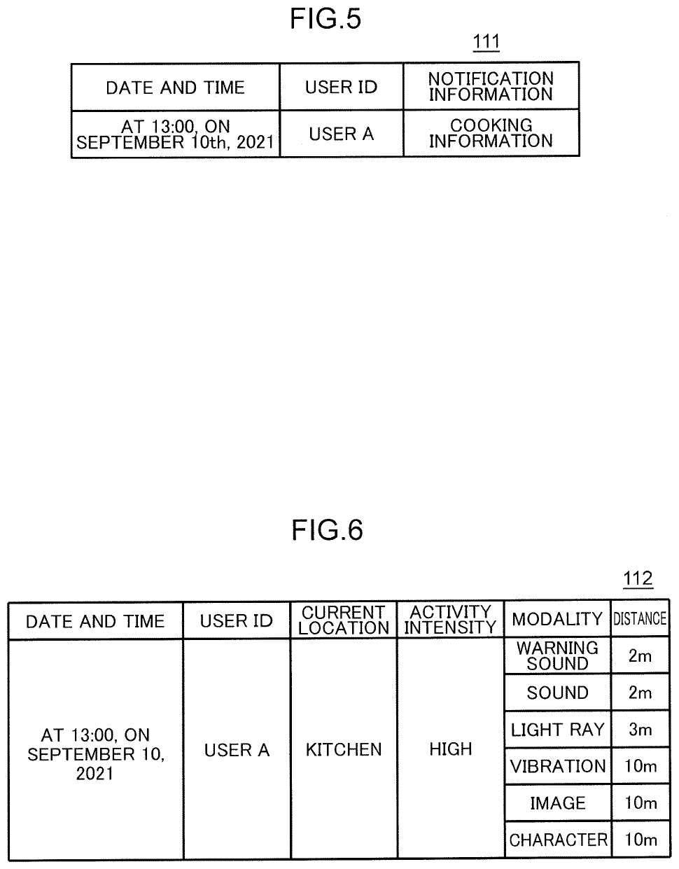

Next, a sequence of a notification process for information in the information notification device 100 will be described. In the description, the first acquisition part 101 to the notification part 105, and the various rule tables stored in the memory 11 will be described in detail. FIG. 4 is a flowchart showing an example of the notification process for information in the information notification device 100. FIG. 5 is a table showing an example of notification request information 111.

### Step S1, Step S2

As shown in FIG. 4, when the communication circuit 12 receives notification request information 111 (FIG. 5) about a request for a notification of information to a specific user (hereinafter, referred to as a “notification target person”) (YES in step S1), the first acquisition part 101 acquires a current location of the notification target person (step S2). By contrast, when the communication circuit 12 does not receive the notification request information 111 (FIG. 5) (NO in step S1), the first acquisition part 101 stays in a standby state.

Specifically, as shown in FIG. 5, the notification request information 111 received in step S1 includes a date and time at which the request for the notification of the information to the notification target person is made, a user ID of the notification target person, and the information to be notified (hereinafter, referred to as “notification information”) to the notification target person. FIG. 5 shows an example of the notification request information 111 transmitted to the information notification device 100 by, for example, a server which provides a service about a cooking recipe. The notification request information 111 indicates a request for notifying a user A of cooking information is made at 13:00 on Sep. 10th in 2021.

In step S2, the first acquisition part 101 firstly acquires sensor information about the notification target person indicated by the notification request information 111 received in step S1.

Specifically, the first acquisition part 101 acquires, from the memory 11, collation data associated with the user ID of the notification target person included in the notification request information 111. The first acquisition part 101 acquires, from among sensor information stored in the memory 11 and transmitted from the monitoring camera and the radio wave sensor, sensor information including: detection date and time information indicating a date and time falling within a predetermined time period (e.g., within thirty minutes) from a current date time; and image data or contour data showing characteristics of the notification target person indicated by the collation data. Alternatively, the first acquisition part 101 acquires, from among sensor information stored in the memory 11 and transmitted from the beacon sensor, sensor information including: detection date and time information indicating a date and time falling within a predetermined time period from the current date and time; and the user ID of the notification target person included in the notification request information 111 received in step S1.

Subsequently, the first acquisition part 101 grasps the arrangement position of the sensor 400 associated with the acquired information with reference to the appliance information about the sensor 400 stored in the memory 11. The sensor 400 associated with the sensor information means the sensor 400 having transmitted the sensor information and identified by the identification information of the sensor 400 included in the sensor information.

Then, the first acquisition part 101 acquires a space including the arrangement position of the sensor 400 as the current location of the notification target person with reference to the floor layout information stored in the memory 11. When the first acquisition part 101 acquires the current location of the notification target person, the memory 11 stores user situation information 112 (FIG. 6) indicating a situation of the notification target person.

FIG. 6 is a table showing an example of the user situation information 112. Specifically, as shown in FIG. 6, the user situation information 112 includes a date and time at which a current location of a notification target person is acquired, a user ID and the current location of the notification target person, and an activity intensity of the notification target person in the current location. The user situation information 112 further includes a group of modalities that are available to notify the notification target person of information, and a distance (hereinafter, referred to as a “notification distance” by each modality) from the current location of the notification target person to an output part that outputs the information by a corresponding modality included in the modality group.

In the disclosure, the “modality” means a user interface (hereinafter, referred to as a “UI”) stimulating at least one of the five senses. Specifically, the UI serves as a contact part between an input and output device for the information and a person, and has operability or a way of allowing the input and output device and the person to transfer information therebetween through at least one of the five senses. Examples of the operability or way will be listed below.
Information is converted into a sound, a voice, a light ray, a vibration, an image, a text, or a video image, each stimulating at least one of the five senses.
Information is notified by using a sound, a voice, a light ray, a vibration, an image, a text, or a video image, each stimulating at least one of the five senses.
An intensity or strength of a sound, a voice, a light ray, a vibration, an image, a text, or a video image, i.e., a sound or voice volume, a light amount, a vibration amount, an image size, a text size, or a video image size, each stimulating at least one of the five senses, is changed depending on a content of the information.
Information is input by a sound, a voice, a gesture manipulation, a touch manipulation (vibration), each stimulating at least one of the five senses.
A combination of objects (e.g., a sound, a voice, a light ray, a vibration, an image, a text, or a video image) each stimulating at least one of the five senses and/or an intensity about each object for use in input and output of the information is changed depending on the content of the information.

The first acquisition part 101 stores information other than an activity intensity of the notification target person. The first acquisition part 101 stores, as a notification distance by a modality, a distance from a predetermined location in a space acquired as the current location of the notification target person to an output part that outputs the information by the modality with reference to the floor layout information stored in the memory 11 and the appliance information about the output system 300. Examples of the predetermined location in the space include an entrance and exit for the space.

For instance, FIG. 6 shows an example in which the first acquisition part 101 stores the date and time “at 13:00 on Sep. 10th in 2021” at which the current location of the notification target person is acquired, the user ID “user A” of the notification target person, the current location “kitchen”, and the distance (notification distance) “2 m” from the current location “kitchen” to the sound output part 31 that outputs information by the modality “warning sound”.

### Step S3

Next, the second acquisition part 102 acquires an activity intensity of the notification target person in the current location of the notification target person acquired in step S2. The activity intensity of the notification target person represents information indicating an intensity of an activity of the notification target person, and can be estimated from, for example, an exercise amount of the notification target person. Specifically, how many times an energy consumed in a current activity by the notification target person is larger than an energy consumed in staying rest can be acquired as the activity intensity of the notification target person.

However, the activity intensity of the notification target person in the disclosure is not limited thereto. For instance, an intensity of the activity which can be estimated from a physical state of the notification target person may be defined as the activity intensity of the notification target person. Specifically, the activity intensity may be defined as high when the notification target person is standing, the activity intensity may be defined as intermediate when the notification target person is sitting, and the activity intensity may be defined as low when the notification target person is lying.

Alternatively, an intensity of an activity which can be estimated from a concentration level of the notification target person may be defined as the activity intensity of the notification target person. For instance, a facial expression, a face direction, a body movement and/or an eye movement of the notification target person may be detected, and the concentration level of the notification target person is calculatable on the basis of a result of the detection. Further alternatively, an action of the notification target person per time period may be estimated from data indicating a history of past actions of the notification target person. Then, an intensity of an activity which can be estimated from the content of the estimated action in the time period may be defined as the activity intensity of the notification target person in the time period.

The activity intensity of the notification target person may be acquired by an acquisition way or a combination of activity intensities acquired by a plurality of acquisition ways.

Specifically, in step S3, the second acquisition part 102 detects an action speed of the notification target person with reference to the sensor information stored in the memory 11 and transmitted from the monitoring camera and the radio wave sensor. The action speed of the notification target person represents an action speed of a whole body of the notification target person, i.e., a speed (hereinafter, referred to as a “moving speed”) at which the notification target person moves, or a speed (hereinafter, refers to as a “portion action speed”) at which a specific portion (e.g., a hand) of the body moves. The second acquisition part 102 acquires the activity intensity of the notification target person on the basis of the action speed of the notification target person.

Hereinafter, step S3 will be described in detail. The second acquisition part 102 acquires, from the memory 11, collation data associated with the user ID included in the notification request information 111. The second acquisition part 102 refers to, among the sensor information stored in the memory 11 and transmitted by the monitoring camera and the radio wave sensor, sensor information including detection date and time information indicating a date and time falling within a predetermined time period (e.g., within thirty minutes) from a current date and time. The second acquisition part 102 acquires, from among the referred sensor information, image data or contour data showing the characteristics of the notification target person indicated by the collation data. The second acquisition part 102 detects an action speed of the notification target person from the image data or the contour data by an image process and an action analyzing process each publicly known.

The memory 11 further stores, in advance, information (hereinafter, referred to as “first relation information”) showing a relation among an action speed of a person, information indicating a whole body or a specific portion of the body in an action at the action speed, and an activity intensity of the person. The first relation information is defined so that the activity intensity of the person is higher as the action speed of the person is faster.

For instance, when a moving speed of the person is 0.8 m/sec. or faster, the person is estimated to move in a hurry to execute a certain activity. When an action speed of a hand of the person is 20 mm/sec. or faster, the person is estimated to execute a certain activity, such as cooking, by using the hand. In this respect, the first relation information associates the moving speed of the person at 0.8 m/sec. or faster and the action speed of the hand at 20 mm/sec. or faster with a “high” degree indicating a high activity intensity.

The first relation information associates a moving speed of the person at 0.4 m/sec. or faster to slower than 0.8 m/sec. and an action speed of the person at 10 mm/sec. or faster to slower than 20 mm/sec. with an “intermediate” degree indicating an intermediate activity intensity. The first relation information associates a moving speed of the person at slower than 0.4 m/sec. and an action speed of the hand at slower than 10 mm/sec. with a “low” degree indicating a low activity intensity.

The second acquisition part 102 acquires an activity intensity associated with the detected action speed of the notification target person in the first relation information. The second acquisition part 102 adds the acquired active intensity of the notification target person to the user situation information 112 (FIG. 6) stored in the memory 11 in step S2. For instance, FIG. 6 shows an example in which the second acquisition part 102 adds the “high” activity intensity of the notification target person acquired in step S3 to the user situation information 112 stored by the first acquisition part 101 in step S2.

### Step S4

Subsequently, the determination part 103 estimates an activity content of the notification target person from the current location of the notification target person acquired in step S2 and the activity intensity of the notification target person acquired in step S3.

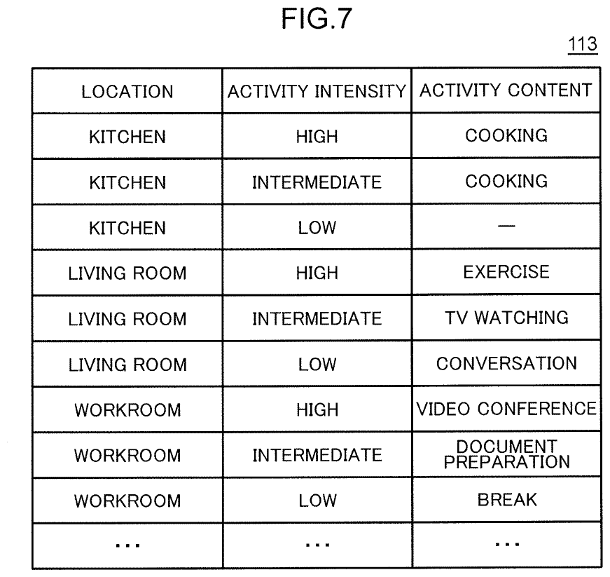

FIG. 7 is a view of an example of an activity estimation table 113. Specifically, the memory 11 stores the activity estimation table 113 for estimation of an activity content of the notification target person. As shown in FIG. 7, the activity estimation table 113 stores a location where the notification target person is likely to be, an intensity of an activity of the notification target person in the location, and an activity content of the notification target person in association with one another. The intensity of the activity of the notification target person in the location where the notification target person is likely to be means an activity intensity of the notification target person in a location where the notification target person is likely to be.

For instance, the activity estimation table 113 in FIG. 7 associates the location “kitchen” where the notification target person is likely to be, the “high” activity intensity of the notification target person in the location “kitchen”, and the activity content “cooking” of the notification target person with one another. This shows that the activity content of the notification target person is estimated as “cooking” when the notification target person is in the “kitchen” and the activity intensity of the notification target person is “high”.

In step S4, the determination part 103 estimates, as the activity content of the notification target person, an activity content associated with a location agreeing with the current location of the notification target person acquired in step S2 and an intensity of an activity agreeing with the activity intensity acquired in step S3 in the activity estimation table 113 (FIG. 7).

### Step S5

Then, the determination part 103 determines, on the basis of the activity content of the notification target person estimated in step S4, an NG(unavailable) modality(a first sort of modality) that hinders an activity of the notification target person.

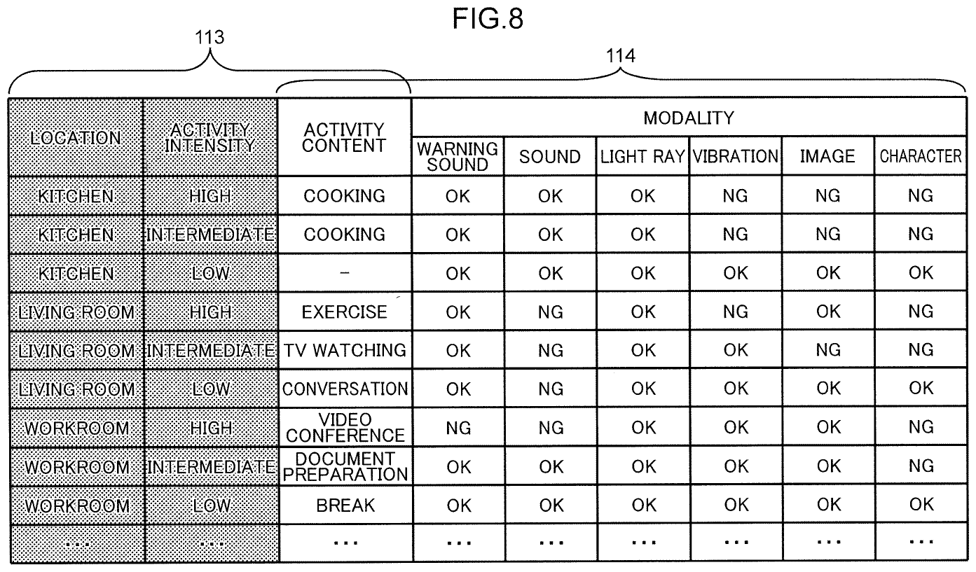

FIG. 8 is a view of an example of a first rule table 114. Specifically, as shown in FIG. 8, the memory 11 stores the first rule table 114 for determination of the NG modality based on the activity content of the notification target person. For explanatory convenience, FIG. 8 shows a table including the activity estimation table 113 (FIG. 7) for estimation of the activity content of the notification target person and the first rule table 114 in combination.

The first rule table 114 associates an activity content of the notification target person with information (hereinafter, referred to as an “OKNG flag”) showing whether each modality included in the group of modalities that are available to notify the notification target person of information is an OK modality or an NG modality. The “OK modality” represents a modality that does not hinder an activity of the notification target person. The “NG modality” represents a modality that hinders the activity of the notification target person.

For instance, the first rule table 114 shown in FIG. 8 associates the activity content “exercise” of the notification target person with three OKNG flags “OK” showing that three modalities “warning sound”, “light ray”, and “image” are OK modalities. Further, the activity content “exercise” of the notification target person is associated with three OKNG flags “NG” showing that three modalities “sound or voice”, “vibration”, and “character” are NG modalities.

In step S5, the determination part 103 determines, as the NG modality, a modality (e.g., a sound, a vibration, or a character) indicated as “NG” by the OKNG flag and associated with the activity content (e.g., exercise) acquired in step S4 in the first rule table 114.

The first rule table 114 shown in FIG. 8 is basically defined in such a manner that the number of NG modalities (e.g., three modalities) associated with an activity content (e.g., a video conference) requiring a high activity intensity is larger than the number of NG modalities (e.g., one modality) associated with an activity content (e.g., preparation for document) requiring a lower activity intensity than the activity content above.

The first rule table 114 shown in FIG. 8 is further defined in such a manner that an NG modality (e.g., a character) associated with an activity content (e.g., the preparation for document) requiring a low activity intensity serves as an NG modality associated with an activity content (i.e., the video conference) requiring a higher activity intensity than the activity content above in a space where an activity which is difficult to be suspended or stopped is executed, such as the “kitchen” and the “workroom”.

Besides, the first rule table 114 shown in FIG. 8 is defined to include a case where an NG modality (e.g., a vibration) associated with an activity content (e.g., an exercise) requiring a high activity intensity disagrees with an NG modality (e.g., an image) associated with an activity content (e.g., TV watching) requiring a lower activity intensity than the activity content above in a space where an activity which is enable to be suspended is executed, such as the “living room”.

The content of the first rule table 114 is not limited to the content shown in FIG. 8. For instance, the notification target person is notified of information by a sound while cooking. In this case, the notification target person may interrupt the cooking and may pay attention to listen to the sound for understanding the notified information. Taking this into consideration, the OKNG flag for the modality “sound” associated with the activity content “cooking” may be “NG” indicating an NG modality in the first rule table 114 shown in FIG. 8.

### Step S6

Next, the selection part 104 selects a modality (a second sort of modality) to notify the notification target person of the information from among modalities which are included in the group of modalities that available to notify the notification target person of the information, and are different from the first sort of modality.

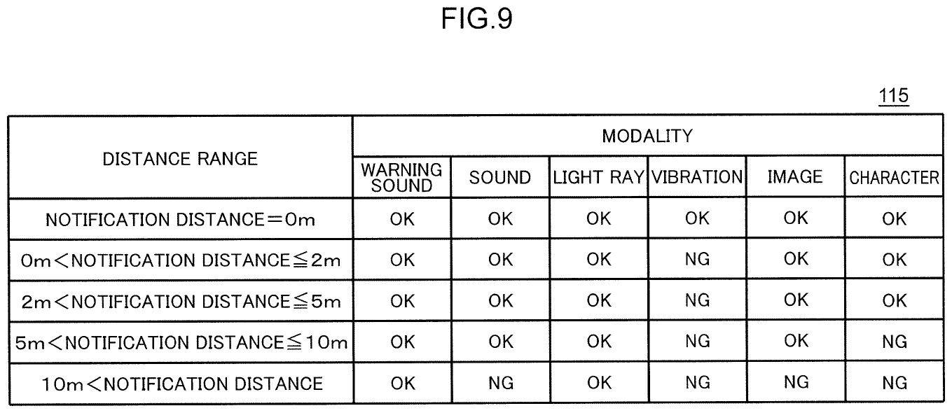

FIG. 9 is a view of an example of a second rule table 115. Specifically, as shown in FIG. 9, the memory 11 stores the second rule table 115 for selection of a modality to notify the notification target person of the information.

The second rule table 115 associates a range of a notification distance (hereinafter, referred to as a “distance range”) by each modality with information (hereinafter, referred to as an “available or unavailable flag”) showing availability or non-availability of each modality to notify the notification target person of the information when the notification distance by the modality falls within the distance.

For instance, the second rule table 115 in FIG. 9 associates each of the distance ranges equal to or shorter than 5 m, i.e., “notification distance=0 m”, “0 m<notification distance≤2 m”, and “2 m<notification distance≤5 m”, with an available or unavailable flag “OK” showing that the modality “character” is available for the notification of the information. By contrast, each of distance ranges exceeding 5 m, i.e., “5 m<distance≤10 m” and “10 m<distance”, is associated with an available or unavailable flag “NG” showing that the modality “character” is unavailable for the notification of the information. In other words, in the second rule table 115 in FIG. 9, the modality “character” is defined to be available to notify the notification target person of the information when the person is within a distance of 5 m or shorter but unavailable to notify the notification target person of the information when the person is at a remote location farther than 5 m.

Similarly, in the second rule table 115 in FIG. 9, the modalities “sound” and “image” are defined to be available to notify the notification target person of the information when the person is within a distance of 10 m or shorter but unavailable to notify the notification target person of the information when the person is at a remote location farther than 10 m.

Besides, in the second rule table 115 in FIG. 9, the modality “vibration” is defined to be available to notify the notification target person of the information when the person is within a distance of 0 m but unavailable to notify the notification target person of the information at a remote location farther than 0 m. In other words, the modality “vibration” is defined to be available to notify the notification target person with the information when the person is in contact with the vibration output part 33 that outputs the information by the modality “vibration”, but the modality “vibration” is unavailable to notify the notification target person when the person is in no contact with the vibration output part 33.

By contrast, in the second rule table 115 in FIG. 9, the modalities “warning sound” and “light ray” are defined to be available to notify the information regardless of any current location of the notification target person.

In step S6, the selection part 104 selects, as a modality to notify the notification target person of the information, a modality (a third sort of modality) that is available to notify the information to the current location of the notification target person or a remote location farther than the current location from among modalities which are included in the group of modalities and are different from the NG modality determined in step S5 with reference to the second rule table 115.

For instance, the memory 11 stores the user situation information 112 shown in FIG. 6. That is to say, the modalities “warning sound”, “sound or voice”, “light ray”, “vibration”, “image”, and “character” are respectively associated with notification distances “2 m”, “2 m”, “3 m”, “10 m”, “10 m”, and “10 m”. In step S5, the three modalities “vibration”, “image”, and “character” are determined as NG modalities.

In this case, in the second rule table 115 (FIG. 9), the modality “warning sound” which is different from the NG modality determined in step S5 is defined to be available to notify the information even when the current location of the notification target person is away farther than the notification distance “2 m” associated with the modality “warning sound”. Thus, the selection part 104 selects the modality “warning sound” as a modality to notify the notification target person of the notification.

Similarly, in the second rule table 115, the modality “sound” which is different from the NG modality determined in step S5 is defined to be available to notify the information even when the current location of the notification target person is away farther than the notification distance “2 m” associated with the modality “sound”. Thus, the selection part 104 selects the modality “sound” as a modality to notify the notification target person of the information.

Further, in the second rule table 115, the modality “light ray” which is different from the NG modality determined in step S5 is defined to be available to notify the information even when the current location of the notification target person is away farther than the notification distance “3 m” associated with the modality “light ray”. Thus, the selection part 104 selects the modality “light ray” as a modality to notify the notification target person of the information.

When a plurality of modalities is selected as modalities to notify a notification target person of information like this example, the selection part 104 may further select only one modality from among the modalities by a predetermined way.

For instance, modalities included in a group of modalities that are available to notify a notification target person of information may be set in a first priority order, and the selection part 104 may select only a modality having a highest rank from among the modalities in the first priority order.

For example, ranks in the first priority order are set to a “first rank”, a “second rank”, a “third rank”, a “fourth rank”, a “fifth rank”, and a “sixth rank” respectively for the modalities “sound”, “light ray”, “image”, “character”, “warning sound”, and “vibration” included in the modality group. In this case, in aforementioned example, the selection part 104 selects, as a modality to notify the notification target person of the information, only the modality “sound” having the “first rank” which is the highest priority rank in the first priority order among the three modalities “warning sound”, “sound”, and “light ray”.

### Step S7

Then, the notification part 105 generates a control command for outputting notification information included in the notification request information 111 (FIG. 5) acquired in step S1 by the modality selected in step S6.

Specifically, the notification part 105 converts the notification information included in the notification request information 111 (FIG. 5) into a data format which can be output by using the modality selected in step S6.

For instance, when the modality selected in step S6 is the modality “warning sound”, the notification part 105 makes a morphological analysis of the notification information included in the notification request information 111 (FIG. 5) to grasp a content of the notification information. The notification part 105 generates a control command of causing the sound output part 31 (FIG. 1) to output a warning sound 311 (FIG. 2) having a higher frequency than a human voice in accordance with a content of the notification information.

When the modality selected in step S6 is the modality “sound”, the notification part 105 generates sound or voice data indicating the notification information included in the notification request information 111 (FIG. 5). The notification part 105 then generates a control command of causing the sound output part 31 (FIG. 2) to output a sound 312 (FIG. 2) indicated by the sound or voice data.

When the modality selected in step S6 is the modality “light ray”, the notification part 105 makes a morphological analysis of the notification information included in the notification request information 111 (FIG. 5) to grasp a content of the notification information. The notification part 105 generates a control command of causing the light output part 32 (FIG. 2) to output a light ray in a color in accordance with the content of the notification information. Alternatively, the notification part 105 generates a control command of causing the light output part 32 (FIG. 2) to output a flashing light ray at time intervals in accordance with the content of the notification information.

When the modality selected in step S6 is the modality “vibration”, the notification part 105 makes a morphological analysis of the notification information included in the notification request information 111 (FIG. 5) to grasp the content of the notification information. The notification part 105 generates a control command of causing the vibration output part 33 (FIG. 2) to vibrate an electric appliance including the vibration output pat 33 in a vibration pattern in accordance with the content of the notification information.

When the modality selected in step S6 is the modality “image”, the notification part 105 generates image data of a still image or a video image indicating the notification information included in the notification request information 111 (FIG. 5). The notification part 105 then generates a control command of causing the image output part 34 (FIG. 2) to display the still image or the video image 341 (FIG. 2) indicated by the image data.

When the modality selected in step S6 is the modality “character”, the notification part 105 generates image data of a character image (text) indicating the notification information included in the notification request information 111 (FIG. 5). The notification part 105 then generates a control command of causing the image output part 34 (FIG. 2) to display a character image 342 (FIG. 2) indicated by the image data.

### Step S8

Next, the notification part 105 notifies the notification information included in the notification request information 111 (FIG. 5) by the modality selected in step S6.

Specifically, in step S8, the notification part 105 transmits the control command generated in step S8 to the output system 300. In this way, the output part that outputs the information by the modality selected in step S6 outputs the notification information in accordance with the control command. As a result, the notification target person is notified of the notification information.

The configuration in the first embodiment notifies the notification target person of the information by a modality which is different from the NG modality that hinders an activity of the notification target person from the group of modalities that are available to notify the notification target person of the information. This configuration thus enables the notification target person to be notified of the information without hindering the activity of the notification target person. Moreover, in the configuration, the NG modality is determined on the basis of an activity content of the notification target person estimated from a current location and an activity intensity of the notification target person. The configuration hence enables the notification target person to be notified of the information without hindering the activity indicated by the activity content.

### Second Embodiment

Described in the first embodiment is an example in which the determination part 103 determines, in step S5 (FIG. 4), an NG modality on the basis of an activity content of a notification target person estimated in step S4 (FIG. 4). The second embodiment excludes step S4 (FIG. 4), and a determination part 103 determines, in step S5 (FIG. 4), an NG modality on the basis of a current location of a notification target person acquired in step S2 (FIG. 4) and an activity intensity of the notification target person acquired in step S3 (FIG. 4).

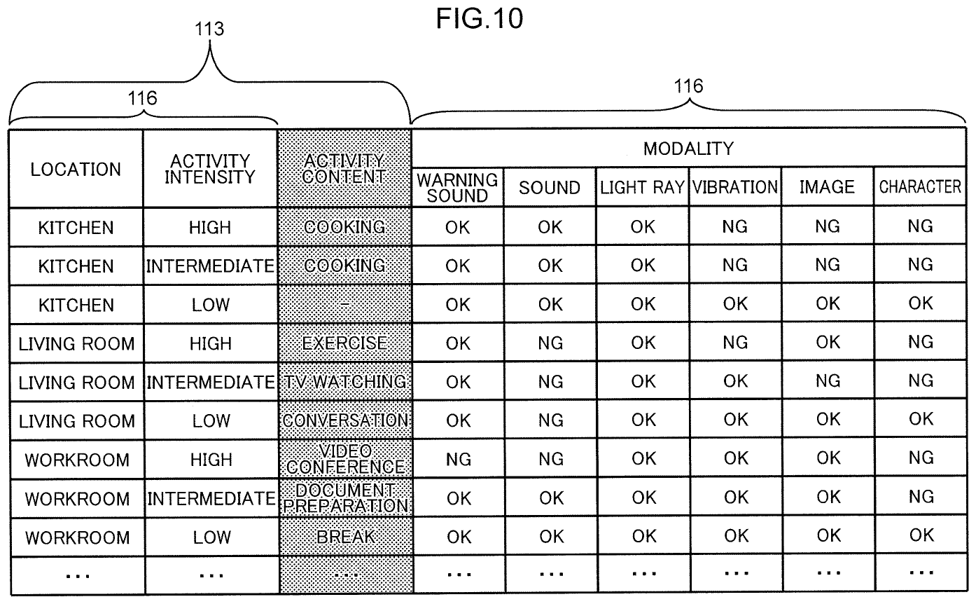

FIG. 10 is a view of an example of a third rule table 116. Specifically, as shown in FIG. 10, a memory 11 stores the third rule table 116 for determination of the NG modality based on a current location of a notification target person and an activity intensity of the notification target person in the current location. For explanatory convenience, FIG. 10 shows a table including an activity estimation table 113 (FIG. 7) for estimation of an activity content of the notification target person and the third rule table 116 in combination.

The third rule table 116 (table) associates a location where the notification target person is likely to be, an intensity of an activity of the notification target person in the location, information (hereinafter, referred to as “OKNG information”) indicating whether each modality included in a group of modalities that are available to notify the notification target person of the information is an OK modality or an NG modality in association with one another. The intensity of the activity of the notification target person in the location where the notification target person is likely to be means an activity intensity of the notification target person in a location where the notification target person is likely to be.

For instance, the third rule table 116 shown in FIG. 10 associates a location “living room” where the notification target person is likely to be and a “high” activity intensity of the notification target person in the “living room” with three pieces of OKNG information “OK” showing that three modalities “warning sound”, “light ray”, and “image” are OK modalities. Besides, the location “living room” where the notification target person is likely to be and the “high” activity intensity of the notification target person in the location “living room” are associated with three pieces of OKNG information “NG” showing that the three modalities “sound, “vibration”, and “character” are NG modalities.

In step S5 in the second embodiment, the determination part 103 determines, as an NG modality, a modality (e.g., a sound, a vibration, a character) indicated as “NG” by the OKNG information and associated with a location (e.g., the living room) agreeing with the current location of the notification target person acquired in step S2 (FIG. 4) and an intensity (e.g., “high”) of an activity agreeing with the activity intensity of the notification target person acquired in step S3 (FIG. 4) in the third rule table 116.

A content of the third rule table 116 is not limited to the content shown in FIG. 10. For instance, under the presumption that the notification target person is notified of information by a sound while executing an activity having a high activity intensity, such as cutting food materials, in the kitchen, the notification target person may have a risk of getting injured by paying attention to listen to the sound for understanding the notified information. By contrast, under the presumption that the notification target person is notified of information by a sound while executing an activity having an intermediate activity intensity, such as putting the food materials into a pan, in the kitchen, the notification target person is considered to have a low risk of getting injured even by paying attention to listen to the sound for understanding the notified information.

Thus, in the third rule table 116 shown in FIG. 10, the OKNG information about the modality “sound” associated with the location “kitchen” and the “high” activity intensity may indicate “NG”. By contrast, the OKNG information about the modality “sound” associated with location “kitchen” and the “intermediate” activity intensity may indicate “OK”.

In this configuration, the NG modality is determined on the basis of the current location of the notification target person and the activity intensity. This consequently enables the notification target person to be notified of information without hindering an activity associated with the current location and the activity intensity of the notification target person.

### Modifications

This disclosure can adopt modifications described below.

(1) In each of the first and second embodiments, an example of notifying a notification target person of information without hindering an activity of the notification target person is described. Similarly, a notification of an existence the notification of information may be given to a notification target person without hindering an activity of the notification target person. This configuration is attained in a manner described below in detail.

In the modification, in step S6 (FIG. 4), a selection part 104 further selects a modality for a notification (hereinafter, referred to as a “trigger notification”) of an existence of a notification of information to a notification target person in the same manner as selecting a modality to notify the notification target person of information.

Specifically, the selection part 104 selects, as a modality for the trigger notification, a modality (a fourth sort of modality) that is available to notify the information to a current location of the notification target person or a remote location farther than the current location from among modalities included in a group of modalities that are available to notify the notification target person of the information and are different from an NG modality determined in step S5 (FIG. 4) with reference to a second rule table 115 (FIG. 9).

Here, when a plurality of modalities is selected for the trigger notification, the selection part 104 may further select only one modality from among the modalities by a predetermined way.

For instance, modalities included in a group of modalities that are available to notify a notification target person of information may be set in a second priority order, and the selection part 104 may select only a modality having a highest rank from among the modalities in the second priority order.

For example, ranks in the second priority order are set to a “first rank”, a “second rank”, a “third rank”, a “fourth rank”, a “fifth rank”, and a “sixth rank” respectively for the modalities “warning sound”, “sound”, “vibration”, “light ray”, “image”, and “character” included in the modality group. In this case, in the example, the selection part 104 selects, as a modality for the trigger notification, only the modality “warning sound” having the “first rank” which is the highest rank in the second priority order among the three modalities “warning sound”, “sound”, and “light ray”.

In step S7 (FIG. 4) in the modification, a notification part 105 generates a control command (hereinafter, referred to as a “trigger notification command”) for outputting information indicating the existence of the notification of information by the modality selected in step S6 for the trigger notification, like the control command for outputting the notification information.

In step S8 (FIG. 4) in the modification, the notification part 105 further transmits a trigger notification command to an output system 300. In this manner, the notification part 105 notifies the notification target person of the information indicating the existence of the notification of information, by the modality for the trigger notification selected in step S6.

This configuration enables a notification target person who is in a current location to be reliably notified of an existence of a notification of information by a modality that is available to notify the information to the current location of the notification target person or a remote location farther than the current location.

(2) In each of the first and second embodiments, an example of notifying a notification target person of information without hindering an activity of the notification target person is described. Similarly, a configuration may make a notification target person input information without hindering an activity of the notification target person. This configuration is attained in a manner described below in detail.

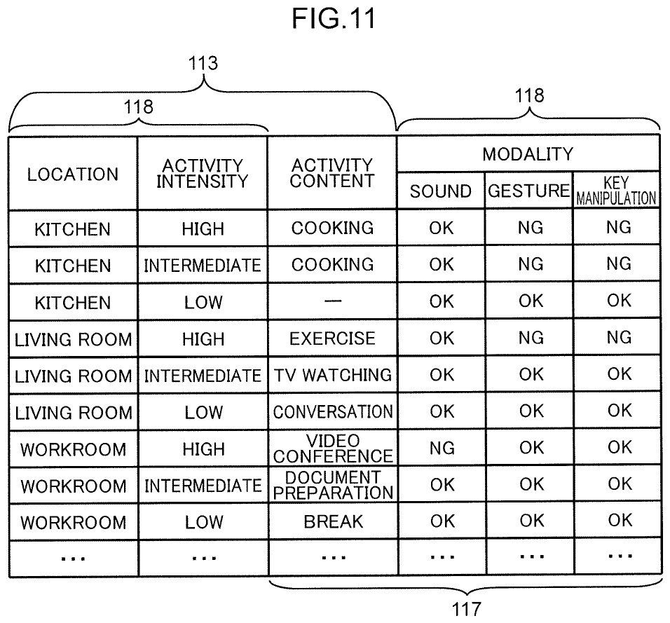

FIG. 11 is a view of an example including a fourth rule table 117 and a sixth rule table 118. Specifically, as shown in FIG. 11, a memory 11 stores, on the basis of an activity content of the notification target person, the fourth rule table 117 for determination of an NG modality from a group (hereinafter, referred to as an “input modality group”) of modalities that are available for the notification target person to input information, like the first rule table 114 (FIG. 8). For explanatory convenience, FIG. 11 shows a table including an activity estimation table 113 (FIG. 7) for estimation of the activity content of the notification target person and the fourth rule table 117 in combination.

The fourth rule table 117 associates an activity content of the notification target person with information (hereinafter, referred to as an “input OKNG flag”) indicating whether each modality included in the input modality group is an OK modality or an NG modality.

For instance, the fourth rule table 117 in FIG. 11 associates the activity content “exercise” of the notification target person with an input OKNG flag “OK” showing that the modality “sound” is an OK modality. Besides, the activity content “exercise” of the notification target person is associated with two input OKNG flags “NG” respectively showing that two modalities “gesture” and “key manipulation” are NG modalities.

In step S5 (FIG. 4) in the modification, a determination part 103 further determines, as an NG modality (a sixth sort of modality) at the time of input of the information by the notification target person, a modality (e.g., “gesture” or “key manipulation”) indicated as “NG” by the OKNG flag and associated with the activity content (e.g., “exercise”) acquired in step S4 (FIG. 4) in the fourth rule table 117. Hereinafter, the NG modality at the time of input of the information by the notification target person is referred to as an “input NG modality”.

The memory 11 further stores a fifth rule table (not shown) having a configuration similar to the configuration of the second rule table 115 (FIG. 9). The fifth rule table associates a range (hereinafter, referred to as an “input distance range”) of a distance (hereinafter, referred to as an “input distance by each modality”) from the current location of the notification target person to an input receiving part that receives an input of information by each modality included in the input modality group with information (hereinafter, referred to as an “input available or unavailable flag”) showing availability or non-availability of each modality for the notification target person to input the information when the input distance by each modality falls within the input distance range.

In step S6 (FIG. 4) in the modification, a selection part 104 further refers to the fifth rule table. The selection part 104 selects a modality (a seventh sort of modality) which is different from the input NG modality determined in step S5 for use in the input of the information by the notification target person from the input modality group. Specifically, the selection part 104 selects, from the input modality group, a modality available for the notification target person to input the information in the current location of the notification target person or a remote location farther than the current location.

In step S7 (FIG. 4) in the modification, a notification part 105 further adds information indicating the availability of the input of information by the modality selected in step S6 to notification information included in notification request information 111 (FIG. 5) and generates a control command for outputting the notification information.

In this manner, after step S8, an output part that outputs the information by the modality selected in step S7 (FIG. 4) outputs information indicating the availability of the input of the information by the modality selected in step S6 together with notification information included in notification request information 111 (FIG. 5) in accordance with the control command. As a result, the notification target person is notified of the notification information together with the availability of the input of the information by the modality selected in step S6.

Here, in the same manner as the second embodiment, step S4 (FIG. 4) may be excluded, and the determination part 103 may determine, in step S5 (FIG. 4), an input NG modality on the basis of the current location of the notification target person acquired in step S2 (FIG. 4) and the activity intensity of the notification target person acquired in step S3 (FIG. 4).

Specifically, as shown in FIG. 11, the memory 11 may store a sixth rule table 118 having a configuration similar to the configuration of the third rule table 116 (FIG. 10). For explanatory convenience, FIG. 11 shows a table including an activity estimation table 113 (FIG. 7) for estimation of an activity content of the notification target person and the sixth rule table 118 in combination.

The sixth rule table 118 associates, in the same manner as the third rule table 116 (FIG. 10), a location where a notification target person is likely to be, an intensity of an activity of the notification target person in the location, and information (hereinafter, referred to as “input OKNG information”) indicating whether each modality included in a group of modalities that are available to notify the notification target person of the information is an OK modality or an NG modality with one another. The intensity of the activity of the notification target person in the location where the notification target person is likely to be means an activity intensity of the notification target person in a location where the notification target person is likely to be.

In step S5, the determination part 103 may determine, as an input NG modality, a modality (e.g., “gesture” or “key manipulation”) indicated as “NG” by the input OKNG information and associated with a location (e.g., the living room) agreeing with the current location of the notification target person acquired in step S2 (FIG. 4) and an intensity (e.g., high) of an activity agreeing with the activity intensity of the notification target person acquired in step S3 (FIG. 4) in the sixth rule table 118.

This configuration notifies the notification target person of availability of an input of information by a modality which is different from an NG modality that hinders an activity of the notification target person. This allows the notification target person to input information by the modality without hindering the activity.

(3) A first acquisition part 101 may acquire, as described below, a current location of a notification target person in more detail in step S2 (FIG. 4).

Specifically, the first acquisition part 101 acquires, in the same manner as described above, sensor information including: detection date and time information indicating a date and time falling within a predetermined time period from a current date and time; and image data or information indicating a contour of a person each showing characteristics of a user indicated by collation data.

When the acquired sensor information includes image data, the first acquisition part 101 grasps, on the basis of a size of an image of the user and a location of the user which are shown in the image indicated by the image data, a relative location of the user to an arrangement position of a sensor 400 (monitoring camera) having transmitted the sensor information by a publicly known image process, the arrangement position serving as a reference position.

By contrast, when the acquired sensor information includes information indicating the contour of the person, the first acquisition part 101 grasps information included in the sensor information and indicating a relative location of the user to an arrangement position of the sensor 400 (radio wave sensor) having transmitted the sensor information, the arrangement position serving as a reference position.

Alternatively, the first acquisition part 101 acquires, from a memory 11, sensor information having been transmitted from a beacon sensor and including: detection date and time information indicating a date and time falling within a predetermined time period from a current date and time; and a user ID included in notification request information 111 received in step S1. The first acquisition part 101 grasps a relative location of the user to an arrangement position of the beacon sensor serving as a reference position, the relative location being included in the sensor information.

With reference to appliance information about a sensor 400 stored in the memory 11, the first acquisition part 101 grasps an arrangement position of the sensor 400 in accordance with the sensor information used to grasp the relative location of the user. The first acquisition part 101 acquires, as a current location of the user, an absolute location for the relative location of the user grasped from the sensor information in the state where the arrangement position of the sensor 400 serves as the reference position.

The first acquisition part 101 may acquire the current location of the user by using sensor information transmitted from a distance measurement sensor. Specifically, the first acquisition part 101 acquires, from among sensor information stored in the memory 11 and transmitted from the distance measurement sensor, sensor information including detection date and time information indicating a date and time falling within a predetermined time period from a current date and time.

The first acquisition part 101 grasps a distance from the distance measurement sensor to a person existing in a predetermined direction, the distance being included in the sensor information transmitted from the distance measurement sensor. The first acquisition part 101 grasps an arrangement position of the distance measurement sensor with reference to appliance information about the distance measurement sensor stored in the memory 11. The first acquisition part 101 acquires, as the current location of the user, a location away from the arrangement position of the distance measurement sensor by the grasped distance in the predetermined direction.

In this case, in step S4 (FIG. 4), a determination part 103 estimates, as an activity content of the notification target person, an activity content associated with: a location including a current location of the notification target person acquired in step S2; and an intensity of an activity agreeing with an activity intensity acquired in step S3; in the activity estimation table 113 (FIG. 7).

In step S5 (FIG. 4), the determination part 103 determines, as an NG modality, a modality indicated as “NG” by OKNG information and associated with: the location including the current location of the notification target person acquired in step S2 (FIG. 4); and an intensity of an activity agreeing with the activity intensity of the notification target person acquired in step S3 (FIG. 4); in the third rule table 116 (FIG. 10).

Moreover, in a case where step S4 (FIG. 4) is excluded in the modification (2), in step S5 (FIG. 4), the determination part 103 determines, as an input NG modality, a modality indicated as “NG” by input OKNG information and associated with: a location including the current location of the notification target person acquired in step S2 (FIG. 4); and an intensity of an activity agreeing with the activity intensity of the notification target person acquired in step S3 (FIG. 4); in the sixth rule table 118 (FIG. 11).

In this configuration, the NG modality is determined on the basis of the detailed current location and the activity intensity of the notification target person, or on the basis of an activity content estimated from the detailed current location and the activity intensity of the notification target person. This consequently enables the notification target person to be notified of information without hindering an activity associated with the detailed current location and the activity intensity of the notification target person.

(4) For instance, in a case where a facility which a notification target person uses is not provided with a monitoring camera, a radio wave sensor, and a beacon sensor, a memory 11 may not store sensor information about the notification target person. In this regard, a first acquisition part 101 may acquire a current location of the notification target person and an activity intensity of the notification target person in the current location, the current location and the activity intensity being received by an input receiving system 500 (FIG. 1). This configuration is attained in a manner described below, for example.

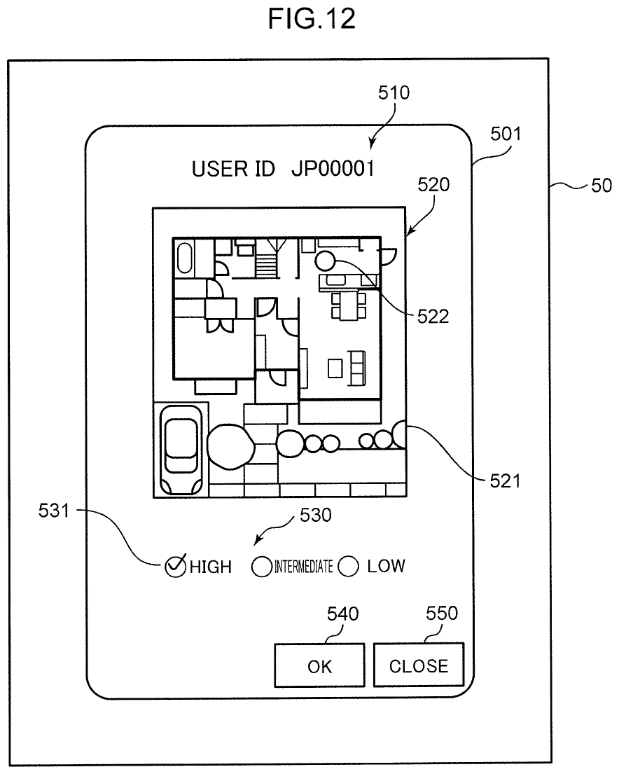

FIG. 12 is an illustration of an example of a user situation input screen image 501. For instance, an electric appliance (hereinafter, referred to as an “input device”) including a key manipulation input receiving part 53 displays the user situation input screen image 501 on a display 50 included in the electric appliance at an appropriate time after the user logs in the input device.

As shown in FIG. 12, the user situation input screen image 501 includes an ID section 510, a location designation section 520, an activity intensity selection section 530, an OK button 540, and a closing button 550.

The ID section 510 shows a user ID of the user having logged in the input device. The location designation section 520 shows an image 521 of a floor layout of a facility which the user uses. A touch screen device or a mouse constituting the key manipulation input receiving part 53 is used to designate a certain location on the image 521, and the input device displays a predetermined mark 522 at the location.

The activity intensity selection section 530 shows radio buttons 531 for alternatively selecting an activity intensity of the user in a location designated in the current location designation section 520. The OK button 540 receives information input on the user situation input screen image 501. The closing button 550 is intended for closing the user situation input screen image 501.

Here, the touch screen device or the mouse constituting the key manipulation input receiving part 53 is used to designate a certain location on the image 521 in the location designation section 520, and one of the radio buttons 531 in the activity intensity selection section 530 is selected. Thereafter, the OK button 540 is pressed.

In this case, the key manipulation input receiving part 53 receives the user ID in the ID section 510, information indicating the location applied with the mark 522, and the activity intensity associated with the selected radio button, and transmits the user ID, the information, and the activity intensity to an information notification device 100. For instance, FIG. 12 shows an example in which the key manipulation input receiving part 53 receives the user ID “JP00001”, information indicating the location applied with the mark 522, and the “high” activity intensity in response to the pressing of the OK button 540, and transmits the user ID, the information, and the activity intensity to the information notification device 100.

A receiving part 106 receives the user ID, the information indicating the location applied with the mark 522, and the activity intensity associated with the selected radio button, each transmitted by the input device. The receiving part 106 stores the received user ID, information indicating the location applied with the mark 522, and activity intensity in the memory 11 in association with a current date and time.

In this case, in step S2 (FIG. 4), the first acquisition part 101 acquires, from the memory 11, the information indicating the location applied with the mark 522, and associated with: the user ID included in notification request information 111; and a current date and time indicating a most recent date and time and falling within a predetermined time period (e.g., within thirty minutes) from an execution date and time of step S2. The first acquisition part 101 acquires the location applied with the mark 522 as the current location of the notification target person.

In step S3 (FIG. 4), a second acquisition part 102 acquires, from the memory 11, an activity intensity associated with: the user ID included in the notification request information 111 received in step S1 (FIG. 4); and the current date and time indicating the most recent date and time and falling within the predetermined time period (e.g., within thirty minutes) from the execution date and time of step S2. The second acquisition part 102 acquires the activity intensity as an activity intensity of the notification target person.

The user situation input screen image 501 may include, in place of the activity intensity selection section 530, an activity content selection section for alternatively selecting an activity content which is likely to be performed by the user in a location designated in the current location designation section 520. The activity content selection section shows radio buttons for alternatively selecting an activity content which is likely to be performed by the user in the location designated in the current location designation section 520.

In this case, whenever a change is seen in the location designated in the current location designation section 520, the key manipulation input receiving part 53 displays the radio buttons for alternatively selecting an activity content which is likely to be performed by the user in the changed location. A receiving part 106 receives the user ID, the information indicating the location applied with the mark 522, and the activity content associated with the selected radio button, each transmitted by the input device. The receiving part 106 stores the received user ID, information indicating the location applied with the mark 522, and activity content in the memory 11 in association with a current date and time.

In this case, step S3 (FIG. 4) is omitted. In step S4 (FIG. 4), a determination part 103 acquires, from the memory 11, information indicating an activity content associated with: the user ID included in the notification request information 111 received in step S1 (FIG. 4); and a current date and time indicating a most current date and time and falling within the predetermined time period (e.g., within thirty minutes) from the date and time of execution of step S2.

(5) In a case where there is another person near a notification target person, a notification of information may be given without hindering an activity of the notification target person, but the notification may hinder an activity of another person. Further, the information to be notified to the notification target person through the notification may be leaked to another person. In this regard, a notification of information to the notification target person may be given in such a manner as not to hinder the activity of another person who is near the notification target person or not to leak the information for the notification target person to another person.

Specifically, after step S5 (FIG. 4), a determination part 103 may detect another person who is different from the notification target person and is in a predetermined range from a current location of the notification target person acquired in step S2 (FIG. 4). The determination part 103 may further add, on the basis of an attribute of another person or a situation of another person, at least one modality to an NG modality, the one modality being one of a modality that hinders the activity of another person and a modality having a possibility of leaking the information to be notified to the notification target person to another person. This configuration is attained in a manner described below, for example.

After step S5 (FIG. 4), the determination part 103 acquires, from a memory 11, sensor information (hereinafter, referred to as “first sensor information”) including: detection date and time information indicating a date and time falling within a predetermined time period from a current date and time; and image data or information indicating a contour of a person each showing characteristics of a user indicated by collation data associated with a user ID included in notification request information 111.

Moreover, the determination part 103 acquires, from the memory 11, sensor information (hereinafter, referred to as “second sensor information”) including: detection date and time information indicating a date and time falling within a predetermined time period from a current date and time; and image data or information indicating a contour of a person each showing characteristics of a user indicated by collation data associated with a user ID different from the user ID included in notification request information 111.

The determination part 103 calculates a distance between an arrangement position of a sensor 400 associated with the first sensor information and an arrangement position of the sensor 400 associated with the second sensor information with reference to the appliance information about the sensor 400 stored in the memory 11. When the calculated distance falls within a predetermined distance range, the determination part 103 detects an existence of another person who is different from the notification target person and associated with the different user ID within a predetermined range from the current location of the notification target person.

The determination part 103 refers to attribute information stored in the memory 11 and included in user information about the notification target person and another person. The determination part 103 further detects an action speed of another person from image data or information indicating a contour of a person each included in the second sensor information by an image process and an action analyzing process each publicly known.

For instance, the attribute information about another person indicates an infant and the action speed of another person indicates a predetermined speed or lower. In this case, the determination part 103 grasps a situation where the infant in the predetermined range from the notification target person is sleeping. In this case, the determination part 103 adds each of the modalities “warning sound” and “sound” that hinders the sleeping of the infant to the NG modality.

Besides, the attribute information about another person indicates that another person belongs to a group which is different from a group (e.g., a company, or a family) to which the notification target person belongs. In this case, the determination part 103 adds, to the NG modality, each of the modalities “image” and “character” that has a possibility of leaking the information to be notified to the notification target person to another person.

In this configuration, at least one of a modality that hinders an activity of another person in a predetermined range from a notification target person and a modality that has a possibility of leaking the information to be notified to the notification target person to another person is added to the NG modality. This configuration thus enables the notification target person to be notified of the information without hindering the activity of another person or leaking the information to be notified to the notification target person to another person.

(6) In a case where there is a plurality of persons in a facility which a notification target person uses, a notification of information to the notification target person may hinder an activity of another person depending on a time period even when the person is not near the notification target person, e.g., late at night in a residence. Hence, a notification of information may be given depending on a time period.

Specifically, after step S5 (FIG. 4), a determination part 103 may acquire a time period in which a current location of a notification target person is acquired in step S2 (FIG. 4). The time period may be defined on hourly basis, or may be defined on plural hour basis. The determination part 103 may add a modality that is associated in advance with the acquired time period and hinders an activity of a person to the NG modality. This configuration is attained in a manner described below, for example.

A memory 11 stores information (hereinafter, referred to as “time period difference NG modality information”) associating each time period with a modality that hinders an activity of a person in each time period. For instance, the time period from 1 am to 6 am is defined as a time period to sleep for the person. Therefore, the memory 11 stores time period difference NG modality information associating the time period from 1 am to 6 am with modalities “warning sound” and “sound” that hinder the activity of sleeping.

After step S5 (FIG. 4), when the time period difference NG modality information includes the time period in which the current location of the notification target person is acquired in step S2 (FIG. 4), the determination part 103 adds a modality associated with the time period in the time period difference NG modality information to the NG modality.

For instance, the memory 11 is configured to store the time period difference NG modality information. In this case, after step S5 (FIG. 4), when the time period in which the current location of the notification target person is acquired in step S2 (FIG. 4) indicates the time period from 1 am to 6 am, the determination part 103 adds the modalities “warning sound” and “sound” to the NG modality.

In this configuration, a modality that is associated in advance with the time period in which the current location of the notification target person is acquired and hinders an activity of a person is added to the NG modality. This configuration thus enables the notification target person to be notified of the information without hindering an activity of a person in a time period in which the location of the notification target person is acquired.

(7) In a case where a group of modalities that are available to notify a notification target person of information includes no modality which is different from an NG modality determined by a determination part 103, the notification of the information to the notification target person fails.

Under the circumstances, a selection part 104 may select a modality to notify a notification target person of information by removing a modality (a fifth sort of modality) having a difficulty in drawing attention of the notification target person who is in an activity from the NG modality determined by the determination part 103. However, when the modality removed from the NG modality is selected as a modality to notify the notification target person of the information, a notification part 105 may notify notification information more prominently than usual by the selected modality. This configuration is attained in a manner described below, for example.

Specifically, modalities each having a difficulty in drawing attention of the notification target person who is in the activity are set to, for example, modalities “sound” and “light ray”, and a memory 11 stores the set modalities in advance. In step S6 (FIG. 4), the selection part 104 removes each modality stored in the memory 11 and having a difficulty in drawing attention of the notification target person who is in the activity from the NG modality determined in step S5 (FIG. 4).

Under the presumption that the modality removed from the NG modality in step S6 (FIG. 4) is selected as a modality to notify the notification target person of the information, the notification part 105 generates, in step S7 (FIG. 4), a control command for outputting notification information more prominently than usual by the selected modality.

For instance, under the presumption that the modality “sound” is removed from the NG modality but is selected as a modality to notify the notification target person of the information in step S6 (FIG. 4), the notification part 105 generates, in step S7 (FIG. 4), a control command for outputting notification information under a greater sound pressure than usual by the modality “sound”.

Alternatively, under the presumption that the modality “light ray” is removed from the NG modality but is selected as a modality to notify the notification target person of the information in step S6 (FIG. 4), the notification part 105 generates, in step S7 (FIG. 4), a control command for outputting notification information at a higher luminous intensity than usual by the modality “light ray”.

This configuration enables the notification target person to be notified of information more prominently than usual even by the modality having a difficulty in drawing attention of the notification target person, and hindering the activity of the notification target person. Hence, the notification target person can grasp the notified information without paying attention to the information through the notification more easily than a usual notification of information by the modality. This consequently attains a reduction in the possibility of hindering the activity of the notification target person.

(8) A receiving part 106 may receive a change in a content of a third rule table 116. This configuration is attained in a manner described below, for example.

On receipt of information (hereinafter, referred to as “change request information”) including a request for a change in the content of the third rule table 116 from a user, a key manipulation input receiving part 53 (FIG. 1) transmits the change request information to an information notification device 100.

When a communication circuit 12 receives the change request information from an input receiving system 500, the receiving part 106 receives the change request information. The receiving part 106 having received the change request information acquires the third rule table 116 stored in the memory 11. The receiving part 106 sends the acquired third rule table 116 to the key manipulation input receiving part 53 (FIG. 1) as a reply.

The key manipulation input receiving part 53 causes a display included in an electric appliance including the key manipulation input receiving part 53 to display the third rule table 116 sent from the information notification device 100 as the reply. When the user uses at least one of a touch screen device, a keyboard, and a mouse to change the content of the third rule table 116, the key manipulation input receiving part 53 transmits the changed third rule table 116 to the information notification device 100.

When the communication circuit 12 receives the changed third rule table 116, the receiving part 106 receives the changed request information, and the memory 11 stores the changed third rule table 116.

The receiving part 106 may allow the user having requested the change in the content of the third rule table 116 to change only a part of the content of the third rule table 116. This configuration is attained in a manner described below, for example.

The key manipulation input receiving part 53 (FIG. 1) transmits, together with the change request information, the user ID of the user having input the change request information to the information notification device 100. The receiving part 106 acquires a current location and an activity intensity of the user in a most recent notification of the notification information to the user, the user being associated with the user ID received together with the change request information by the communication circuit 12. The receiving part 106 sends only the current location, the activity intensity of the user, and associated OKNG information each included in the third rule table 116 acquired from the memory 11 to the key manipulation input receiving part 53 (FIG. 1) as a reply.

The key manipulation input receiving part 53 causes a display included in an electric appliance including the key manipulation input receiving part 53 to display a part of the content of the third rule table 116 sent from the information notification device 100 as the reply. When the user uses at least one of a touch screen device, a keyboard, and a mouse to change the part of the content of the third rule table 116, the key manipulation input receiving part 53 transmits the changed part of the content of the third rule table 116 to the information notification device 100.

When the communication circuit 12 receives the changed part of the content of the third rule table 116, the receiving part 106 updates a part of the content of the third rule table 116 stored in the memory 11 with the changed part of the content of the third rule table 116.

Moreover, in the same manner as foregoing, the receiving part 106 may receive a change in a part of or whole of the content of each of the first rule table 114, the fourth rule table 117, and the sixth rule table 118.

This configuration succeeds in receiving a change in the content of each kind of rule table for use in determining of the first sort of modality. This configuration thus attains appropriate determination of the first sort of modality by appropriately changing the content of each kind of table.

(9) In step S3 (FIG. 4), a way of acquiring an activity intensity of a notification target person by a second acquisition part 102 is not limited to the way described in the first embodiment.

For instance, the second acquisition part 102 may detect a posture of a notification target person with reference to sensor information stored in a memory 11 and transmitted by a monitoring camera and a radio wave sensor, and acquire an activity intensity on the basis of the posture of the notification target person. The posture of the notification target person includes a posture of standing, sitting, or lying of the notification target person. This configuration is attained in a manner described below, for example.

The second acquisition part 102 acquires, from the memory 11, collation data associated with a user ID included in notification request information 111. The second acquisition part 102 refers to, among sensor information stored in the memory 11 and transmitted by the monitoring camera and the radio wave sensor, sensor information including detection date and time information indicating a date and time falling within a predetermined time period (e.g., within thirty minutes) from a current date and time. The second acquisition part 102 acquires, from among the referred sensor information, image data or contour data showing characteristics of the notification target person indicated by collation data. The second acquisition part 102 detects the posture of the notification target person from the image data or the contour data by a known image process.

The memory 11 further stores, in advance, information (hereinafter, referred to as “second relation information”) indicating a relation between a posture of a person and an activity intensity of the person.

When the person is in the posture of standing, the person is estimated to be in execution of a certain activity. When the person is in the posture of sitting, the person is estimated to be in execution of a certain activity only using an upper body part thereof. When the person is in the posture of lying, the person is estimated to be in relaxing or sleeping without moving the body thereof.

From these perspectives, in the second relation information, the posture of standing is associated with a “high” degree indicating a high activity intensity. In the second relation information, the posture of sitting is associated with an “intermediate” degree indicating an intermediate activity intensity. In the second relation information, the posture of lying is associated with a “low” degree indicating a low activity intensity.

The second acquisition part 102 acquires an activity intensity associated with the posture of the notification target person in the second relation information.

Alternatively, among two acquisition ways consisting of a way of acquiring an activity intensity on the basis of an action speed of a notification target person described in the first embodiment and a way of acquiring the activity intensity on the basis of a posture of the notification target person as described above, the second acquisition part 102 may acquire the activity intensity by one way that is associated in advance with a current location the notification target person acquired by a first acquisition part 101. This configuration is attained in a manner described below, for example. Hereinafter, the way of acquiring the activity intensity on the basis of the action speed of the notification target person described in the first embodiment is referred to as a first acquisition way. The way of acquiring the activity intensity on the basis of the posture of the notification target person as described above is referred to as a second acquisition way.

The memory 11 further stores, in advance, information (hereinafter, referred to as “third relation information”) indicating a relation between a location where a person is likely to be and a way of acquiring an activity intensity of the person.

For instance, when a person is in a space with a limitation to activities, such as a kitchen and a workroom, an activity intensity of the person is considered to vary depending on an action speed of the person. By contrast, when the person is in a space with a higher capacity for a plurality of activities, such as a living room, an activity intensity of the person is considered to vary depending on a posture of the person.

From these perspectives, in the third relation information, a location indicating a space with a limitation to activities, such as the kitchen and the workroom, is associated with the first acquisition way. In the third relation information, a location indicating a space with a higher capacity for a plurality of activities, such as the living room, is associated with the second acquisition way.

The second acquisition part 102 acquires the activity intensity of the notification target person by the first acquisition way or the second acquisition way that is associated with a location including a current location of the notification target person acquired by the first acquisition part 101 in the third relation information.

Alternatively, the second acquisition part 102 may adopt, among the two acquisition ways of the first acquisition way and the second acquisition way, one acquisition way that is associated in advance with the number of postures which the notification target person is likely to take in the current location of the notification target person acquired by the first acquisition part 101 to acquire the activity intensity. This configuration is attained in a manner described below, for example.

The memory 11 further stores, in advance, information (hereinafter, referred to as “fourth relation information”) indicating a relation between a location where a person is likely to be and the number of postures which the person is likely to take. The memory 11 further stores, in advance, information (hereinafter, referred to as “fifth relation information”) indicating a relation between the number of postures which the person is likely to take and an acquisition way for the activity intensity of the person.

For instance, in the fourth relation information, a location indicating a space where a person is likely to freely take three postures of standing, sitting, and lying, such as the living room, is associated with “3” as the number of postures which the person is likely to take. In the fourth relation information, a location indicating a space where a person is likely to take two postures of standing and lying, such as a bedroom, is associated with “2” as the number of postures which the person is likely to take. In the fourth relation information, a location indicating a space where a person faces a difficulty in taking two or more postures among the three postures of standing, sitting, and lying, such as the kitchen and the workroom, is associated with “1” as the number of postures which the person is likely to take.

When the person is in a space where the person is likely to take two or more postures among the three postures of standing, sitting, and lying, such as the living room, the activity intensity of the person is considered to vary depending on a posture of the person. By contrast, when the person is in a space where the person faces a difficulty in taking two or more postures among the three postures of standing, sitting, and lying, such as the kitchen and the workroom, the activity intensity of the person is considered to vary depending on an action speed of the person.

From these perspectives, in the fifth relation information, the number of postures “2” or “3” which the person is likely to take is associated with the second acquisition way. In the fifth relation information, the number of postures “1” which the person is likely to take is associated with the first acquisition way.

In this regard, the second acquisition part 102 acquires the number of postures which the person associated with a location including the current location of the notification target person acquired by the first acquisition part 101 is likely to take in the fourth relation information. The second acquisition part 102 acquires the activity intensity of the notification target person by the first acquisition way or the second acquisition way that is associated with the acquired number of postures which the person is likely to take in the fifth relation information.

(10) An output system 300 (FIG. 1) may include one or more of the sound output parts 31, the light output parts 32, the vibration output parts 33, and the image output parts 34, and each of the one or more of the output parts may include a plurality of the output parts. This configuration thus may include a plurality of output parts that output information by a modality selected in step S6 (FIG. 4). In this case, in step S7 (FIG. 4), a notification part 105 may select one output part from among the output parts by a predetermined way, and generate a control command for outputting notification information to the selected one output part. Examples of the predetermined way include a way of selecting the one output part from among the output parts at random, and a way of giving a priority rank to each of the output parts in advance and selecting an output part having the highest priority rank.

(11) For instance, in a case where a notification target person is cooking in a kitchen while listening to music, a notification process for information shown in FIG. 4 is executed. There is a possibility in step S6 that a modality “sound” is selected as a modality (hereinafter, referred to as a “notification modality”) to notify notification information on the basis of an activity intensity of the notification target person. Alternatively, a sensor 400 may be broken and a wrong activity intensity may be acquired in step S3 (FIG. 4), and then, a modality which is inappropriate for the notification target person may be selected as the notification modality. In each case, a notification of the notification information by the notification modality may fail to make the notification target person grasp an existence of the notification of the notification information or a content of the notification information.

Here, processing (hereinafter, referred to as “appropriateness determination processing”) of determining whether the notification of the notification information by the notification modality is appropriate or inappropriate on the basis of a reaction from the notification target person to the notification of the notification information by the notification modality may be executed. When the notification of the notification information by the notification modality is determined to be inappropriate in the appropriateness determination processing, another notification modality may be selected and the notification information may be notified by the selected notification modality. This configuration is attained in a manner described below, for example.

After step S8 (FIG. 4), a processor 10 executes appropriateness determination processing. In the appropriateness determination processing, the processor 10 determines whether a notification of notification information by a notification modality is appropriate after a lapse of a predetermined stand-by time period (e.g., five minutes) from a time at which a notification part 105 notifies the notification information by the notification modality in step S8 (FIG. 4).

Specifically, the processor 10 acquires collation data associated with a user ID of the notification target person from a memory 11. The processor 10 refers to, among sensor information stored in the memory 11 and transmitted by a monitoring camera and a radio wave sensor, sensor information including detection date and time information indicating a time falling within a predetermined reaction time period (e.g., within one minute) from a time at which the notification part 105 notifies the notification information.

The processor 10 acquires, from among the referred sensor information, image data or contour data showing the characteristics of the notification target person indicated by the collation data. The processor 10 determines that the notification of the notification information by the notification modality is appropriate when a predetermined reaction behavior of the notification target person is detected from the image data or the contour data by an image process and a behavior analyzing process each publicly known. The reaction behavior means an action taken by a person who recognizes the notified information. Examples of the reaction behavior include changing a facial direction, clapping hands, raising both hands, and making a fist.

By contrast, the processor 10 determines that the notification of the notification information by the notification modality is inappropriate when failing to acquire, from among the referred sensor information, image data or contour data showing the characteristics of the notification target person indicated by the collation data and failing to detect a reaction behavior of the notification target person from acquired image data or contour data.

The appropriateness determination processing is not limited to the one described above, and may be realized in a manner described below. The sensor 400 further includes a microphone. The microphone may be an internal microphone incorporated in, for example, a smart speaker or a laptop computer. The microphone detects a sound or voice around the microphone, and transmits, to the information notification device 100, sensor information including sound data indicating the detected sound or voice and an arrangement position of the microphone as detection information. Accordingly, the collation data stored in the memory 11 further includes sound data indicating a sound or voice of the user.

The processor 10 refers to, among the sensor information stored in the memory 11 and transmitted from a monitoring camera and the microphone, sensor information including detection date and time information indicating a time falling within the reaction time period (e.g., within one minute) from the time at which the notification part 105 notifies the notification information.

The processor 10 acquires, from among the referred sensor information, image data showing the characteristics of the notification target person indicated by the collation data or sound data showing a sound of the notification target person indicated by the collation data. The processor 10 determines that the notification of the notification information by the notification modality is appropriate when a predetermined reaction feeling of the notification target person is detected from the image data or the sound data by an image process and a voice process each publicly known. The reaction feeling means a feeling expressed by a person who recognizes the notified information. Examples of the reaction feeling include a joy, an anger, a sadness, a surprise, and a silence.

By contrast, the processor 10 determines that the notification of the notification information by the notification modality is inappropriate when failing to acquire, from among the referred sensor information, image data showing the characteristics of the notification target person indicated by the collation data and sound data indicating the sound of the notification target person indicated by the collation data, and failing to detect a reaction feeling of the notification target person from acquired image data or contour data.

When the notification of the notification information by the notification modality is determined to be inappropriate in the appropriateness determination processing, the processor 10 repetitively performs appropriateness determination processing after step S2 (FIG. 4) and subsequent steps until a notification of the notification information by a notification modality is determined to be appropriate in certain subsequent appropriateness determination processing. The processor 10 finishes the notification process for the information shown in FIG. 4 when the notification of the notification information by the notification modality is determined to be appropriate in the certain appropriateness determination processing.

In step S6 (hereinafter, referred to as “re-step S6) for the repetition of step S2 and the subsequent steps and the appropriateness determination processing, a selection part 104 may select, as a notification modality, a modality which is not selected as the notification modality after the notification process shown in FIG. 4 is started.

Besides, in re-step S6, the selection part 104 may select the notification modality on the basis of initial request information set in advance by the notification target person. The initial request information includes information indicating a modality desired by a user to be adopted for a notification of notification information. The initial request information is input into a user terminal or the information notification device 100 by the user and stored in the memory 11 in advance in association with a user ID of the user.

In other words, in re-step S6, the selection part 104 may refer to the initial request information associated with a user ID of the notification target person stored in the memory 11 and select a modality indicating the initial request information as a notification modality.

For instance, in a case where the notification target person wears an eyepatch, a notification of notification information to the notification target person by a notification modality stimulating a sense of sight may fail to make the notification target person grasp an existence of the notification of the notification information or a content of the notification information. Hence, in re-step S6, the selection part 104 may select a notification modality on the basis of a state of a portion (hereinafter, referred to as a “relevant body portion”) of the notification target person which is stimulable by the modality. The relevant body portion includes an eye, an ear, and a hand. This configuration is attained in a manner described below, for example.

In re-step S6, the selection part 104 acquires collation data associated with the user ID of the notification target person from the memory 11. The selection part 104 refers to, among the sensor information stored in the memory 11, sensor information including detection date and time information including a time falling within the reaction time period (e.g., within one minute) from a time at which the notification part 105 notifies the notification information in step S8 which is most recent (FIG. 4).

The selection part 104 acquires, from among the referred sensor information, image data and contour data showing the relevant body portion of the notification target person indicated by the collation data. The processor 10 acquires information (hereinafter, referred to as “portion state information”) indicating a state of the relevant body portion of the notification target person from the image data and the contour data by an image process and an action analysis process each publicly known. Examples of the state of the relevant body portion include a state where an eye is closed, a state where an eye is covered, a state where an ear is covered, and a state where a hand is used.

The memory 11 stores a seventh rule table associating portion state information with one or more modalities and one or more priority ranks in a priority order for adopting each modality among the one or more modalities.

For instance, when an eye of the notification target person is closed, the notification target person is considered to recognize notification information in a notification by the modality “vibration” or “sound” more easily than the notification information in a notification by the modality “light ray”. Further, when an eye of the notification target person is covered with a hand, notification information in a notification by the modality “sound” is considered to be more recognizable than the notification information in a notification by the modality “vibration”. In the seventh rule table, portion state information that “eye is covered” indicating a state where the eye is covered is stored in association with the three modalities “sound”, “vibration”, and “light ray”, and further, the three modalities “sound”, “vibration”, and “light ray” are stored respectively in association with priority ranks “1”, “2”, and “3”.

In this regard, in re-step S6, the selection part 104 selects as a notification modality, from among the one or modalities associated with the portion state information acquired from among the sensor information, a modality which is not selected as a notification modality after the beginning of the notification process for the information shown in FIG. 4 and is associated with the highest rank with reference to the seventh rule table stored in the memory 11.

Further, in step S8 (hereinafter, referred to as “re-step S8”) to be performed when a notification of notification information by a notification modality is determined to be inappropriate in appropriateness determination processing, a mode for notifying notification information by a notification modality may be changed to a second mode which is different from a first mode adopted in notifying previous notification information by using the same modality as the notification modality.

For instance, in step S8 (FIG. 4) or re-step S8, after notification information is notified by the notification modality “vibration” in the first mode “continuous vibration for ten seconds”, the notification of the notification information by the notification modality “vibration” is determined to be inappropriate in appropriateness determination processing. In re-step S6 performed immediately after the determination, the modality “vibration” is reselected as the notification modality.

In this case, in re-step S8 to be performed after the determination, the notification part 105 may notify the notification information by the notification modality “vibration” in the second mode “intermittent vibration for twenty seconds” which is different from the first mode “continuous vibration for ten seconds”. This configuration is attained in a manner described below, for example.

The memory 11 stores an eighth rule table associating one or more modalities and a plurality of modes to notify notification information by each modality in association with each other. In re-step S8, the notification part 105 notifies the notification information in the second mode which is different from the first mode used in a previous notification of the notification information by using the notification modality among the modes associated with notification modalities selected in re-step S6 which is most recent with reference to the eighth rule table.

Specifically, in step S8 (FIG. 4), the notification part 105 transmits, to an output system 300, a control command generated in step S7 (FIG. 4) and additionally including a control command of instructing a notification of notification information in a predetermined initial mode. In this way, an output part that outputs the information by the modality selected in step S6 outputs the notification information in the initial mode in accordance with the control command.

Similarly, in re-step S8, the notification part 105 transmits, to the output system 300, a control command generated in step S7 which is most recent and additionally including a control command of instructing a notification of the notification information in the second mode. In this way, the output part that outputs the information by the modality selected in re-step S6 outputs the notification information in the second mode in accordance with the control command.

Further, after the notification of the notification information to the notification target person by the notification modality, the memory 11 may record information (hereinafter, referred to as “determination result information”) indicating a result of the appropriateness determination processing per execution of the appropriateness determination processing. Accordingly, in re-step S6, a notification modality may be further selected to notify the notification target person of the notification information on the basis of the determination result information stored in the memory 11. This configuration is attained in a manner described below, for example.

Specifically, the processor 10 causes the memory 11 to store the determination result information indicating a result of appropriateness determination processing per execution of the appropriateness determination processing. The determination result information includes the user ID of the notification target person, a modality for appropriateness determination processing, and information indicating whether the notification of the notification information is appropriate in the appropriateness determination processing. The modality for the appropriateness determination processing represents a notification modality used in notifying the notification target person of the notification information in step S8 (see FIG. 4) which is immediately before the appropriateness determination processing.

In re-step S6, the selection part 104 selects a modality, as the notification modality, in the order from a modality having more pieces of information showing that the notification of the notification information is determined to be appropriate with reference to the determination result information including the user ID of the notification target person and stored in the memory 11.

(12) This disclosure may appropriately combine the first embodiment, the second embodiment, and modifications (1) to (11) in various manners.

The present disclosure is useful for giving a notification of information without hindering an activity of a user in a facility where various kinds of activities are available.

1. An information notification method for notifying information by a modality which stimulates at least one of human five senses, the information notification method comprising:
by a computer,
acquiring a current location of a notification target person;
acquiring an activity intensity of the notification target person in the current location;
determining, on the basis of the current location and the activity intensity, a first sort of modality that hinders an activity of the notification target person from a group of modalities that are available to notify the notification target person of the information;
selecting a second sort of modality used to notify the notification target person of the information from among the modalities which are included in the group of modalities and are different from the first sort of modality; and
notifying the notification target person of the information by the second sort of modality.

2. The information notification method according to claim 1, wherein,
in the determining of the first sort of modality, an activity content of the notification target person is estimated from the current location and the activity intensity, and the first sort of modality is determined on the basis of the activity content.

3. The information notification method according to claim 1, further comprising:
detecting another person who is different from the notification target person and located in a predetermined range from the current location; and
adding, on the basis of an attribute of the another person or a situation of the another person, at least one of a modality that hinders an activity of the another person and a modality that has a possibility of leaking the information to be notified to the notification target person to the another person, to the first sort of modality.

4. The information notification method according to claim 1, further comprising:
acquiring a time period in which the current location is acquired; and
adding, to the first sort of modality, a modality that is associated in advance with the time period and hinders an activity of a person.

5. The information notification method according to claim 1, wherein,
in the determining of the first sort of modality, with reference to a table associating a location where the notification target person is likely to be with an intensity of an activity of the notification target person in the location and judgment information indicating whether each modality included in the group of modalities hinders the activity of the notification target person, a modality which is indicated to hinder the activity of the notification target person by the judgment information associated with the location agreeing with the current location and the intensity of the activity in the location agreeing with the activity intensity in the current location is determined as the first sort of modality, the method further comprising
receiving a change in the content of the table.

6. The information notification method according to claim 1, wherein,
in the selecting of the second sort of modality, a third sort of modality that is available to notify the information to the current location or a remote location farther than the current location is selected as the second sort of modality from modalities which are included in the group of modalities and are different from the first sort of modality.

7. The information notification method according to claim 6, wherein the modalities included in the group of modalities are set in a first priority order, and,
in the selecting of the second sort of modality, in a case where the third sort of modality includes a plurality of modalities, a modality having the highest rank in the first priority order in the third sort of modality is selected as the second sort of modality.

8. The information notification method according to claim 1, further comprising notifying the notification target person of an existence of the notification of the information by a fourth sort of modality that is available to notify the notification target person of the existence of the notification of the information to the current location or a remote rotation farther than the current location among the modalities which are included in the group of modalities and are different from the first sort of modality.

9. The information notification method according to claim 8, wherein the modalities included in the group of modalities are set in a second priority order, and,
in a case where the fourth sort of modality includes a plurality of modalities, the notification target person is notified of the existence of the notification of the information by a modality having the highest rank in the second priority order in the fourth sort of modality.

10. The information notification method according to claim 1, further comprising:
removing a fifth sort of modality having a difficulty in drawing attention of the notification target person who is in the activity from the first sort of modality; and
selecting the fifth sort of modality as the second sort of modality, and notifying the notification target person of the information more prominently than usual by the fifth sort of modality.

11. The information notification method according to claim 1, further comprising:
determining, on the basis of the current location and the activity intensity, a sixth sort of modality that hinders the activity of the notification target person from a group of input modalities that are available for an input of the information by the notification target person; and
selecting a seventh sort of modality for the input of the information by the notification target person from among modalities which are included in the group of input modalities and are different from the sixth sort of modality, wherein,
in the notifying of the information by the second sort of modality, a notification that an input of the information by the seventh sort of modality is available is further given.

12. The information notification method according to claim 1, wherein,
in the acquiring of the current location, a sensor is used to detect whether the notification target person is in a space where the sensor is arranged, and
the space where the sensor having detected the notification target person is arranged is acquired as the current location.

13. The information notification method according to claim 1, further comprising receiving an input of the current location, wherein,
in the acquiring of the current location, the received current location is acquired.

14. The information notification method according to claim 1, wherein,
in the acquiring of the activity intensity, a sensor is used to detect an action speed of the notification target person in a space where the sensor is arranged, and
the activity intensity is acquired on the basis of the action speed of the notification target person.

15. The information notification method according to claim 1, wherein,
in the acquiring of the activity intensity, a sensor is used to detect a posture of the notification target person in a space where the sensor arranged, and
the activity intensity is acquired on the basis of the posture of the notification target person.

16. The information notification method according to claim 1, wherein,
in the acquiring of the activity intensity, among two acquisition ways consisting of a way of using a sensor to detect an action speed of the notification target person and acquiring an activity intensity on the basis of the detected action speed of the notification target person and a way of using a sensor to detect a posture of the notification target person and acquiring the detected activity intensity, one way that is associated in advance with the current location is performed to acquire the activity intensity.

17. The information notification method according to claim 1, wherein,
in the acquiring of the activity intensity, among two acquisition ways consisting of a way of using a sensor to detect an action speed of the notification target person and acquiring an activity intensity on the basis of the detected action speed of the notification target person and a way of using a sensor to detect a posture of the notification target person and acquiring the detected activity intensity, one way that is associated in advance with the number of postures which the notification target person is likely to take in the current location is performed to acquire the activity intensity.

18. The information notification method according to claim 1, further comprising receiving an input of the activity intensity, wherein,
in the acquiring of the activity intensity, the received activity intensity is acquired.

19. An information notification device that notifies information by a modality which stimulates at least one of human five senses, the information notification device comprising:
a first acquisition part that acquires a current location of a notification target person;
a second acquisition part that acquires an activity intensity of the notification target person in the current location;
a determination part that determines, on the basis of the current location and the activity intensity, a first sort of modality that hinders an activity of the notification target person from a group of modalities that are available to notify the notification target person of the information;
a selection part that selects a second sort of modality used to notify the notification target person of the information from among the modalities which are included in the group of modalities and are different from the first sort of modality; and
a notification part that notifies the notification target person of the information by the second sort of modality.

20. A non-transitory computer readable storage medium storing a program that causes a computer included in an information notification device that notifies information by a modality which stimulates at least one of human five senses, the program comprising:
causing the computer to serve as:
a first acquisition part that acquires a current location of a notification target person;
a second acquisition part that acquires an activity intensity of the notification target person in the current location;
a determination part that determines, on the basis of the current location and the activity intensity, a first sort of modality that hinders an activity of the notification target person from a group of modalities that are available to notify the notification target person of the information;
a selection part that selects a second sort of modality used to notify the notification target person of the information from among the modalities which are included in the group of modalities and are different from the first sort of modality; and
a notification part that notifies the notification target person of the information by the second sort of modality.
